(19) United States
(12) Patent Application Publication
(10) Pub. No.: US 2009/0288007 A1
(43) Pub. Date: Nov. 19, 2009

(54) SPATIAL INTERFACES FOR REALTIME NETWORKED COMMUNICATIONS

(75) Inventors: Matthew Leacock, Sunnyvale, CA (US); David Van Wie, Eugene, OR (US); Paul J. Brody, Palo Alto, CA (US)

Correspondence Address: EDOUARD GARCIA;Attorney At Law, 1351 Cuernavaca Circulo, Mountain View, CA, 94040, US

(73) Assignee: Social Communications Company, Eugene, OR (US)

(21) Appl. No.: 12/509,658

(22) Filed: Jul. 27, 2009

Related U.S. Application Data
(63) Continuation-in-part of application No. 12/354,709, filed on Jan. 15, 2009.
(60) Provisional application No. 61/042,714, filed on Apr. 5, 2008.

(51) Int. Cl. G06F 3/048

(52) U.S. Cl. 715/716; 715/757; 715/748; 715/758

(57) ABSTRACT

A current realtime communication session is established between communicants operating on respective network nodes. A spatial visualization of the current realtime communication session is displayed. The spatial visualization includes a graphical representation of each of the communicants in spatial relation to a graphical representation of a virtual area. During the current communication session, visual cues are depicted in the spatial visualization that show current communication states of the communicants, where each of the communication states corresponds to a state of a respective communication channel over which a respective one of the communicants is configured to communicate.

### CROSS-REFERENCE TO RELATED APPLICATIONS

This application is a continuation-in-part of prior U.S. patent application Ser. No. 12/354,709, filed Jan. 15, 2009, which claims the benefit of U.S. Provisional Application No. 61/042,714, filed Apr. 5, 2008. The entirety of prior U.S. patent application Ser. No. 12/354,709, filed Jan. 15, 2009, is incorporated herein by reference.

This application also relates to the following co-pending patent applications, the entirety of each of which is incorporated herein by reference: U.S. patent application Ser. No. 11/923,629, filed Oct. 24, 2007; U.S. patent application Ser. No. 11/923,634, filed Oct. 24, 2007; and U.S. patent application Ser. No. 12/418,270, filed Apr. 3, 2009.

### BACKGROUND

When face-to-face communications are not practical, people often rely on one or more technological solutions to meet their communications needs. These solutions typically are designed to simulate one or more aspects of face-to-face communications. Traditional telephony systems enable voice communications between callers. Instant messaging (also referred to as “chat”) communications systems enable users to communicate text messages in real time through instant message computer clients that are interconnected by an instant message server. Some instant messaging systems additionally allow users to be represented in a virtual environment by user-controllable graphic objects (referred to as “avatars”). Interactive virtual reality communication systems enable users in remote locations to communicate over multiple real-time channels and to interact with each other by manipulating their respective avatars in three-dimensional virtual spaces. What are needed are improved interfaces for realtime network communications.

### SUMMARY

In one aspect, the invention features a method in accordance with which a current realtime communication session is established between communicants operating on respective network nodes. A spatial visualization of the current realtime communication session is displayed. The spatial visualization includes a graphical representation of each of the communicants in spatial relation to a graphical representation of a virtual area. During the current communication session, visual cues are depicted in the spatial visualization that show current communication states of the communicants, where each of the communication states corresponds to a state of a respective communication channel over which a respective one of the communicants is configured to communicate.

In another aspect, the invention features a method in accordance with which a current realtime communication session is established between communicants operating on respective network nodes. A spatial visualization of the current realtime communication session is displayed. The spatial visualization includes a graphical representation of each of the communicants in spatial relation to a graphical representation of a virtual area. During the current communication session, a log of event descriptions is presented. The event descriptions describe respective events involving interactions of the communicants in the virtual area. The event descriptions are presented in contextual association with elements of the spatial visualization of the current realtime communication session.

In another aspect, the invention features a method in accordance with which receipt of a command from a first communicant operating on a first network node to initiate a private communication with a second communicant operating on a second network node prompts a response that includes the following. A current realtime communication session is established between the first and second network nodes. A private virtual area associated with the first and second communicants is identified. Context configuration data associated with the private virtual area and generated in response to interactions of the first and second communicants in the private virtual area is retrieved. A spatial visualization of the current realtime communication session is displayed. The spatial visualization includes graphical representations of the first and second communicants in spatial relation to a graphical representation of the virtual area configured in accordance with the context configuration data.

The invention also features apparatus operable to implement the method described above and computer-readable media storing computer-readable instructions causing a computer to implement the method described above.

### DESCRIPTION OF DRAWINGS

FIG. 1 is a diagrammatic view of an embodiment of a network communication environment that includes a first client network node, a second client network node, and a synchronous conferencing server node.

FIG. 2 is a flow diagram of an embodiment of a method of visualizing realtime networked communications on a client network node.

FIGS. 3A-3D, 4, and 5 are diagrammatic views of spatial interfaces for realtime networked communications.

FIG. 6 is a diagrammatic view of an embodiment of a spatial interface for realtime networked communications.

FIG. 7 is a flow diagram of an embodiment of a method of managing realtime networked communications.

FIG. 8 is a diagrammatic view of an embodiment of a spatial interface integrated with a realtime communications interface.

FIG. 9 is a diagrammatic view of an embodiment of the spatial interface shown in FIG. 8 integrated with an additional spatial interface.

FIG. 10 is a diagrammatic view of an embodiment of a graphical user interface.

FIG. 11 is a flow diagram of an embodiment of a method of managing realtime networked communications between networked communicants in a private virtual area.

FIG. 12 is a diagrammatic view of an embodiment of a process of generating a spatial visualization of a current realtime communication session.

FIG. 13 is a diagrammatic view of an embodiment of a data model relating area identifiers to communicants, template specifications, and context data.

FIG. 14 is a diagrammatic view of an embodiment of a data model relating interaction record identifiers with area identifiers and interaction records.

FIG. 15 is a diagrammatic view of an embodiment of a spatial interface integrated with a realtime communications interface for realtime networked communications in a private virtual area.

FIG. 16 is a diagrammatic view of an embodiment of the spatial interface shown in FIG. 15.

FIG. 17 is a diagrammatic view of an embodiment of a spatial interface integrated with a realtime communications interface for realtime networked communications in a private virtual area.

FIG. 18 is a diagrammatic view of an embodiment of a network communication environment that includes a first client network node, a second client network node, and a virtual environment creator.

FIG. 19 is a block diagram of the network communication environment of FIG. 1 that shows components of an embodiment of a client network node.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

A “communicant” is a person who communicates or otherwise interacts with other persons over one or more network connections, where the communication or interaction may or may not occur in the context of a virtual area. A “user” is a communicant who is operating a particular network node that defines a particular perspective for descriptive purposes.

A “realtime contact” of a user is a communicant or other person who has communicated with the user via a realtime communications platform.

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “computer data file” is a block of information that durably stores data for use by a software application.

A “window” is a visual area of a display that typically includes a user interface. A window typically displays the output of a software process and typically enables a user to input commands or data for the software process. A window that has a parent is called a “child window.” A window that has no parent, or whose parent is the desktop window, is called a “top-level window.” A “desktop” is a system-defined window that paints the background of a graphical user interface (GUI) and serves as the base for all windows displayed by all software processes.

A “database” is an organized collection of records that are presented in a standardized format that can be searched by computers. A database may be stored on a single computer-readable data storage medium on a single computer or it may be distributed across multiple computer-readable data storage media on one or more computers.

A “data sink” (referred to herein simply as a “sink”) is any of a device (e.g., a computer), part of a device, or software that receives data.

A “data source” (referred to herein simply as a “source”) is any of a device (e.g., a computer), part of a device, or software that originates data.

A “network node” (also referred to simply as a “node”) is a junction or connection point in a communications network. Exemplary network nodes include, but are not limited to, a terminal, a computer, and a network switch. A “server” network node is a host computer on a network that responds to requests for information or service. A “client” network node is a computer on a network that requests information or service from a server. A “network connection” is a link between two communicating network nodes. The term “local network node” refers to a network node that currently is the primary subject of discussion. The term “remote network node” refers to a network node that is connected to a local network node by a network communications link. A “connection handle” is a pointer or identifier (e.g., a uniform resource identifier (URI)) that can be used to establish a network connection with a communicant, resource, or service on a network node. A “network communication” can include any type of information (e.g., text, voice, audio, video, electronic mail message, data file, motion data stream, and data packet) that is transmitted or otherwise conveyed from one network node to another network node over a network connection.

Synchronous conferencing refers to communications in which communicants participate at the same time. Synchronous conferencing encompasses all types of networked collaboration technologies, including instant messaging (e.g., text chat), audio conferencing, video conferencing, application sharing, and file sharing technologies.

A “communicant interaction” is any type of direct or indirect action or influence between a communicant and another network entity, which may include for example another communicant, a virtual area, or a network service. Exemplary types of communicant communications include communicants communicating with each other in realtime, a communicant entering a virtual area, and a communicant requesting access to a resource from a network service.

“Presence” refers to the ability and willingness of a networked entity (e.g., a communicant, service, or device) to communicate, where such willingness affects the ability to detect and obtain information about the state of the entity on a network and the ability to connect to the entity.

A “realtime data stream” is data that is structured and processed in a continuous flow and is designed to be received with no delay or only imperceptible delay. Realtime data streams include digital representations of voice, video, user movements, facial expressions and other physical phenomena, as well as data within the computing environment that may benefit from rapid transmission, rapid execution, or both rapid transmission and rapid execution, including for example, avatar movement, instructions, text chat, realtime data feeds (e.g., sensor data, machine control instructions, transaction streams and stock quote information feeds), and file transfers.

A “link” is a connection between two network nodes and represents the full bandwidth allocated by the two nodes for real-time communication. Each link is divided into channels that carry respective real-time data streams. Channels are allocated to particular streams within the overall bandwidth that has been allocated to the link.

A “virtual area” (also referred to as an “area” or a “place”) is a representation of a computer-managed space or scene. Virtual areas typically are one-dimensional, two-dimensional, or three-dimensional representations; although in some embodiments a virtual area may correspond to a single point. Oftentimes, a virtual area is designed to simulate a physical, real-world space. For example, using a traditional computer monitor, a virtual area may be visualized as a two-dimensional graphic of a three-dimensional computer-generated space. However, virtual areas do not require an associated visualization to implement switching rules. A virtual area typically refers to an instance of a virtual area schema, where the schema defines the structure and contents of a virtual area in terms of variables and the instance defines the structure and contents of a virtual area in terms of values that have been resolved from a particular context.

A “virtual area application” (also referred to as a “virtual area specification”) is a description of a virtual area that is used in creating a virtual environment. The virtual area application typically includes definitions of geometry, physics, and realtime switching rules that are associated with one or more zones of the virtual area.

A “virtual environment” is a representation of a computer-managed space that includes at least one virtual area and supports realtime communications between communicants.

A “zone” is a region of a virtual area that is associated with at least one switching rule or governance rule. A “switching rule” is an instruction that specifies a connection or disconnection of one or more realtime data sources and one or more realtime data sinks subject to one or more conditions precedent. A switching rule controls switching (e.g., routing, connecting, and disconnecting) of realtime data streams between network nodes communicating in the context of a virtual area. A governance rule controls a communicant's access to a resource (e.g., an area, a region of an area, or the contents of that area or region), the scope of that access, and follow-on consequences of that access (e.g., a requirement that audit records relating to that access must be recorded). A “renderable zone” is a zone that is associated with a respective visualization.

A “position” in a virtual area refers to a location of a point or an area or a volume in the virtual area. A point typically is represented by a single set of one-dimensional, two-dimensional, or three-dimensional coordinates (e.g., x, y, z) that define a spot in the virtual area. An area typically is represented by the three-dimensional coordinates of three or more coplanar vertices that define a boundary of a closed two-dimensional shape in the virtual area. A volume typically is represented by the three-dimensional coordinates of four or more non-coplanar vertices that define a closed boundary of a three-dimensional shape in the virtual area.

A “spatial state” is an attribute that describes where a user has presence in a virtual area. The spatial state attribute typically has a respective value (e.g., a zone_ID value) for each of the zones in which the user has presence.

A “communication state” is an attribute that describes a state of a respective communication channel over which a respective one of the communicants is configured to communicate.

In the context of a virtual area, an “object” (also sometimes referred to as a “prop”) is any type of discrete element in a virtual area that may be usefully treated separately from the geometry of the virtual area. Exemplary objects include doors, portals, windows, view screens, and speakerphone. An object typically has attributes or properties that are separate and distinct from the attributes and properties of the virtual area. An “avatar” is an object that represents a communicant in a virtual area.

As used herein, the term “includes” means includes but not limited to, the term “including” means including but not limited to. The term “based on” means based at least in part on.

### II. OVERVIEW

A. Introduction

The embodiments that are described herein provide improved systems and methods for visualizing realtime network communications. In particular, these embodiments apply a spatial metaphor on top of realtime networked communications. The spatial metaphor provides a context for depicting the current communication states of the communicants involved in realtime networked communications. The spatial metaphor also provides a context for organizing the presentation of various interface elements that are used by communicants to participate in realtime networked communications.

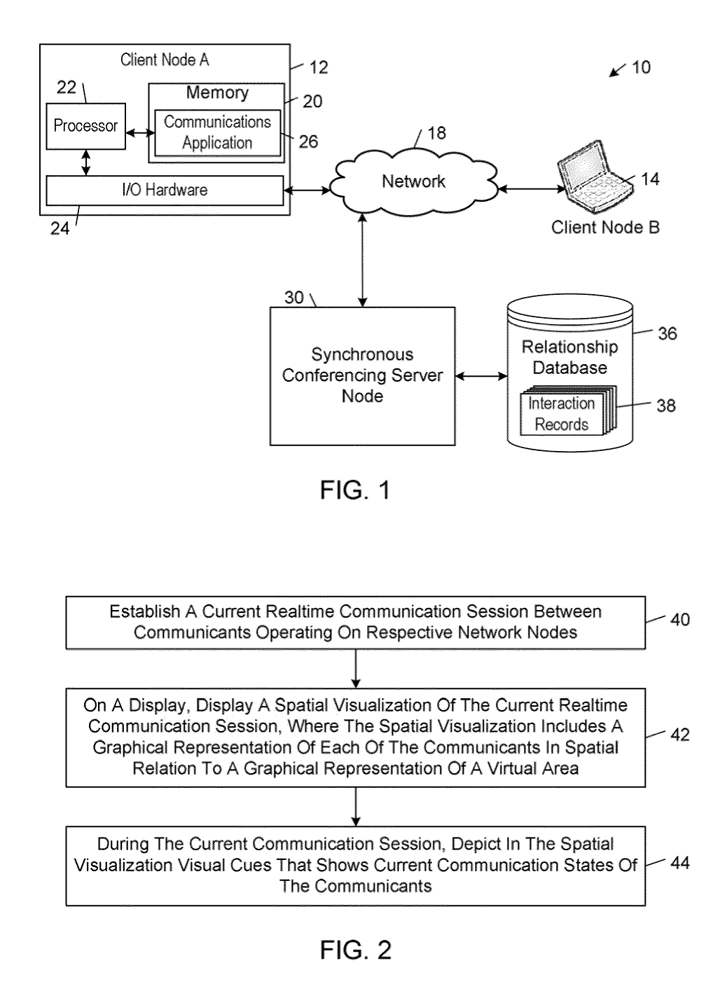

FIG. 1 shows an embodiment of an exemplary network communications environment 10 that includes a first client network node 12 (Client Node A), a second client network node 14 (Client Network Node B), and a synchronous conferencing server 16 that are interconnected by a network 18. The first client network node 12 includes a computer-readable memory 20, a processor 22, and input/output (I/O) hardware 24 (including a display). The processor 22 executes at least one communications application 26 that is stored in the memory 20. The second client network node 14 typically is configured in substantially the same way as the first client network node 12. In some embodiments, the synchronous conferencing server 16 manages realtime communication sessions between the first and second client nodes 12, 14. The network infrastructure service environment 30 also maintains a relationship database 36 that contains records 38 of interactions between communicants. Each interaction record 38 describes the context of an interaction between a pair of communicants. As explained in detail below, the communications application 26 and the synchronous conferencing server 16 together provide a platform (referred to herein as “the platform”) for creating a spatial visualization context that enhances realtime communications between communicants operating on the network nodes 12, 14.

FIG. 2 shows an embodiment of a method that is implemented by the communications application 26 operating on one or both of the first and second network nodes 12, 14. This process typically is performed in response to a request from a communicant on one of the network nodes 12, 14 to initiate a realtime communication session with another communicant operating on the other network node. The communications application 26 establishes a current realtime communication session between communicants operating on respective network nodes (FIG. 2, block 40). On a display, the communications application 26 displays a spatial visualization of the current realtime communication session (FIG. 2, block 40). The spatial visualization includes a graphical representation of each of the communicants in spatial relation to a graphical representation of a virtual area. The virtual area may be represented graphically by any type of one-dimensional, two-dimensional, or three-dimensional view that situates the graphical representations of the communicants in respective positions in a visual space. During the current communication session, the communications application 26 depicts visual cues in the spatial visualization that show current communication states of the communicants (FIG. 2, block 44). Each of the communication states typically corresponds to a state of a respective communication channel (e.g., text chat, audio, video, application share, and file share channel) over which a respective one of the communicants is configured to communicate.

In some embodiments, a log of event descriptions that describe respective events involving interactions of the communicants in the virtual area is presented on the display in contextual association with elements of the spatial visualization of the current realtime communication session. The log of event descriptions and the graphical representation of the virtual area typically are displayed in a single graphical user interface window. The log of event descriptions may include, for example, at least one of: text of a chat conversation between the communicants in the virtual area; a description of a data file shared by a respective one of the communicants in the virtual area; and a description of an application shared by a respective one of the communicants in the virtual area. The event descriptions in the log typically are visually associated with respective ones of the graphical representations of the communicants involved in the events described by the respective event descriptions. For example, in some embodiments, a respective label is associated with each of the event descriptions, where the respective label has a respective visual appearance that matches a visual element of the graphical representation of the communicant involved in the event described by the respective event description. The log of event descriptions typically are stored in one or more database records that are indexed by an identifier of the virtual area.

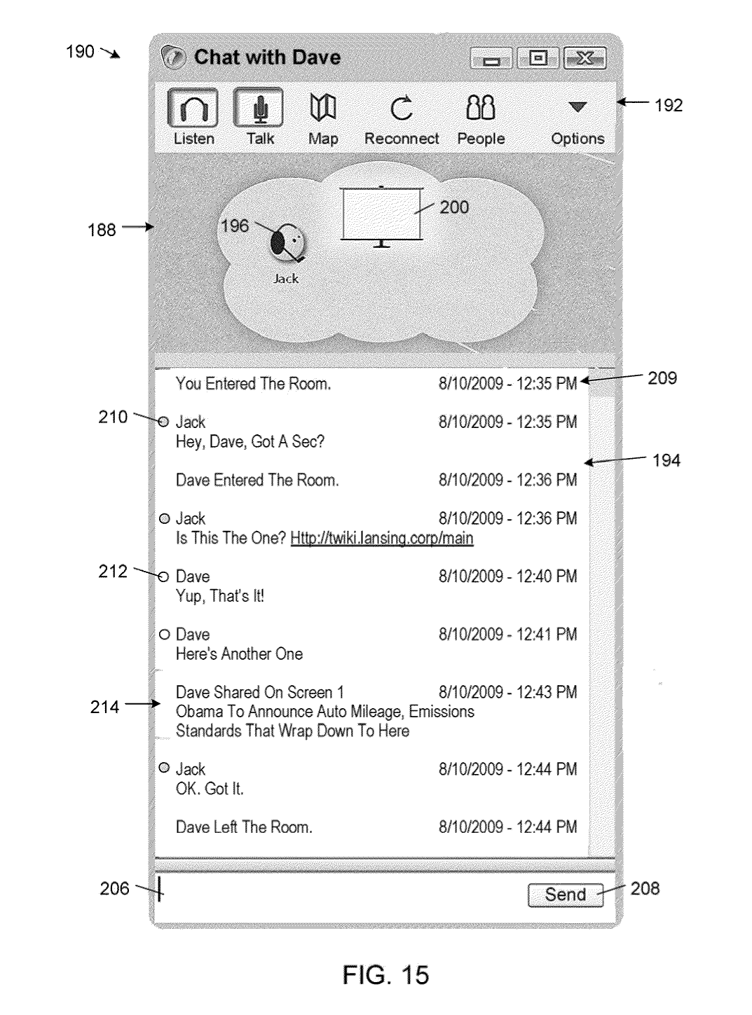

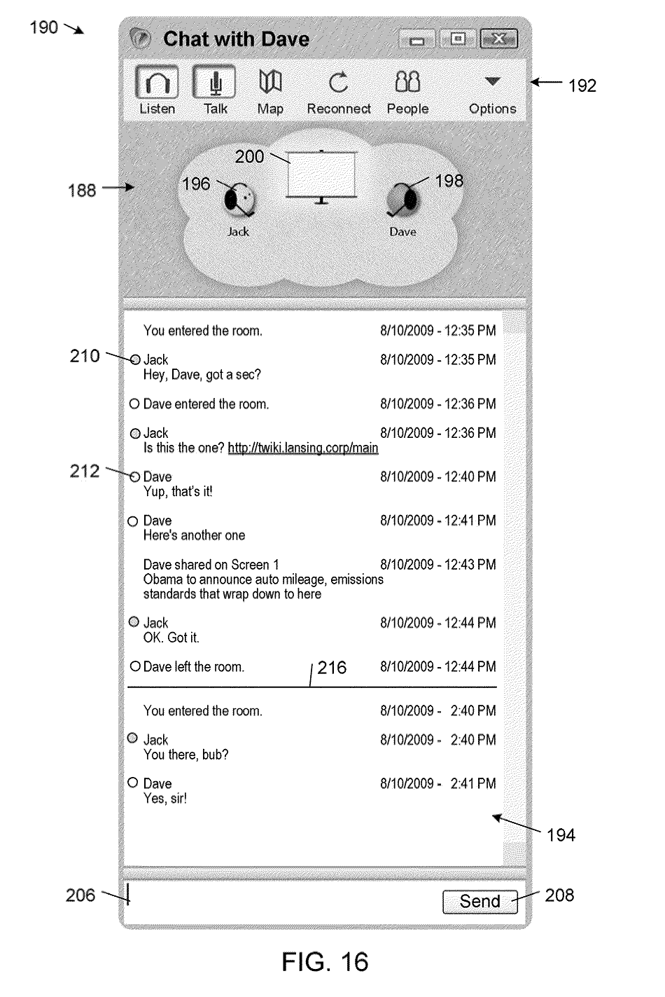

In some embodiments, one or more props are displayed in the virtual area, where each prop represents a respective communication channel for realtime communications between the communicants during the communication session. For example, a communicant-selectable table prop may be displayed in the virtual area, and a file share session between the communicants may be initiated in response to selection of the table prop by one of the communicants; or a communicant-selectable viewscreen prop may be displayed in the virtual area, and an application sharing session may be initiated between the communicants in response to selection of the viewscreen prop by one of the communicants. In some embodiments, a spatial property of the graphical representation of a respective one of the communicants in relation to a respective one of the props is changed in response to selection of the respective prop by the respective communicant. For example, the graphical representation of the respective communicant may be depicted adjacent the selected prop, it may be reoriented to face the selected prop, and/or the graphical representation of the communicant may be changed (e.g., a pair of eyes may be added to the body of a communicant's sprite when it is positioned adjacent to a viewscreen prop, as shown in FIGS. 15 and 16).

In some embodiments, a realtime instant messaging communication channel is established between the communicants during the current communication session. In these embodiments, a current chat log of a current chat conversation between the communicants occurring during the current communication session typically is displayed in association with the graphical representation of the virtual area. A respective prior chat log of a prior chat conversation that occurred during a prior communication session between the communicants in the virtual area typically is displayed in association with the current chat log. The graphical representation of a given one of the communicants may be dynamically modulated in response to receipt of a respective realtime chat stream from the given communicant over the realtime instant messaging communication channel such that the current communication state of the given communicant is reflected in the dynamic modulation of the graphical representation of the given communicant.

In some embodiments, a graphical representation of a file sharing prop is displayed in the virtual area. In response to selection of the file sharing prop by a respective one of the communicants, the graphical representation of the respective communicant typically is depicted adjacent the file sharing prop and a realtime file sharing session typically is initiated in the virtual area. A data file shared by the respective communicant during the realtime file sharing session typically is stored in a data storage device with an index that includes an identifier of the virtual area, and a communicant-selectable graphical representation of the data file typically is displayed on the file sharing prop. A download of the data file to the network node from which a given one of the communicants is operating typically is initiated in response to selection of the graphical representation of the file by the given communicant.

In some embodiments, a graphical representation of an application sharing prop is displayed in the virtual area. In response to selection of the application sharing prop by a respective one of the communicants, the graphical representation of the respective communicant typically is depicted adjacent the application sharing prop and a realtime application sharing session typically is initiated in the virtual area. Screen shots from the network node from which the respective communicant is operating typically are shared with one or more of the other communicants during the realtime application sharing session. A graphical indication that an application that is being shared typically is displayed in connection with the application sharing prop. In some embodiments, a first graphical representation of the application sharing prop is displayed during periods of application sharing between the communicants in the virtual area and a second graphical representation of the application sharing prop different from the first graphical representation is displayed during periods free of application sharing between the communicants.

In some embodiments, in response to a command from a given one of the communicants to activate an audio sink communication channel, a realtime audio communication channel is established between the given communicant and one or more of the other communicants configured as audio sources, and the depicting graphical representation of the given communicant is modified to show that the given communicant is configured as an audio sink. Analogously, in response to a command from a given one of the communicants to activate an audio source communication channel, a realtime audio communication channel is established between the given communicant and one or more of the other communicants configured as audio sinks, and the graphical representation of the given communicant is modified to show that the given communicant is configured as an audio source.

In some embodiments, a static view of the graphical representation of the virtual area is displayed throughout the current communication session, and the communicants are unable to navigate the graphical representations of the communicants outside the static view of the virtual area.

In some embodiments, in response to receipt of a command from a first one of the communicants to initiate a private communication with a second one of the communicants, the current realtime communication session between the first and second communicants is established, and the graphical representations of the first and second communicants are displayed in spatial relation to a graphical representation of a virtual area that is indexed by identifiers of the first and second communicants.

In some embodiments, an end state of a prior realtime communication session between the communicants is determined from data that is indexed by an identifier of the virtual area and that describes events that occurred during a prior communication session between the communicants, and the graphical representation of a virtual area is displayed in a state that corresponds to the determined end state of the prior communication session between the communicants.

B. Exemplary Spatial Interfaces for Realtime Communication Sessions

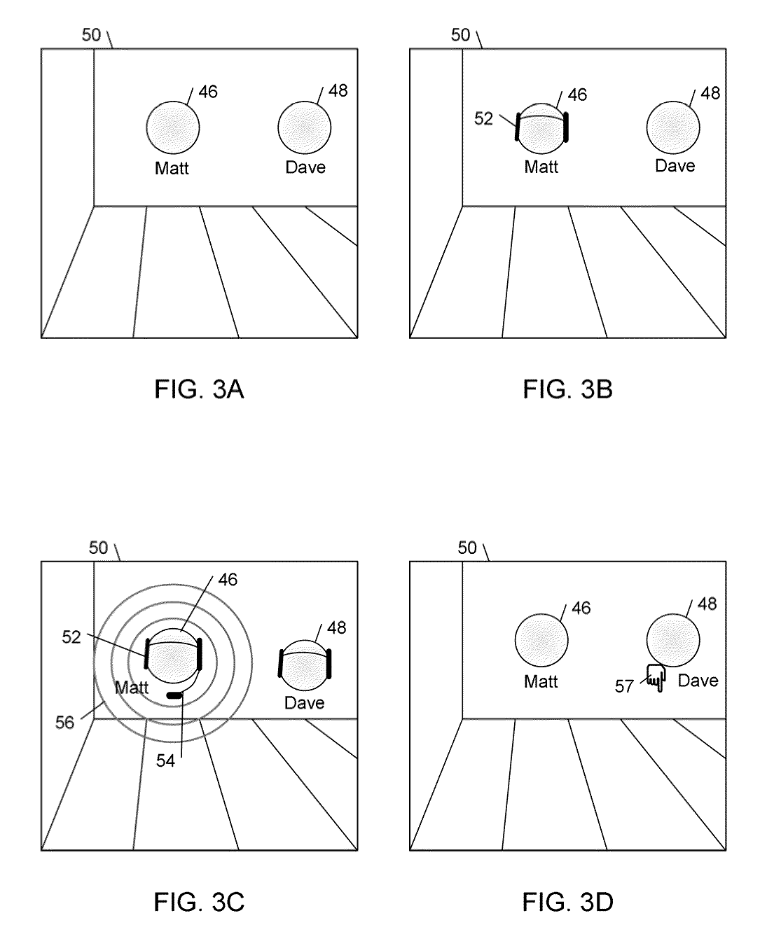

FIGS. 3A-3D respectively show embodiments of spatial visualizations of a realtime communication session that include visual cues that reveal the current communication states of two networked communicants involved in the realtime communication session. In these embodiments, the spatial visualizations include a graphical representation 46, 48 of each of the communicants in spatial relation to a graphical representation 50 of a virtual area. In particular, the virtual area is represented by a perspective view of a three-dimensional visual space in which the graphical representations 46, 48 of the communicants can have different respective positions. In the illustrated embodiments, each communicant is represented by a respective circular sprite 46, 48. The states of various communication channels over which the respective communicant is configured to communicate are revealed by visual cues that are shown in the spatial visualization. For example, the on or off state of a communicant's local speaker channel is depicted by the presence or absence of a headphones graphic 52 on the communicant's sprite 46. Thus, when the speakers of the communicant who is represented by the sprite 46 are on, the headphones graphic 52 is present (as shown in FIG. 3B) and, when the communicant's speakers are off, the headphones graphic 52 is absent (as shown in FIG. 3A). The on or off state of the communicant's microphone is depicted by the presence or absence of a microphone graphic 54 on the communicant's sprite 46 and a series of concentric circles 56 that radiate away from the communicant's sprite 46 in a series of expanding waves. Thus, when the microphone is on, the microphone graphic 54 and the radiating concentric circles 56 are present (as shown in FIG. 3C) and, when the microphone is off, the microphone graphic 54 and the radiating concentric circles 56 are absent (as shown in FIGS. 3A, 3B, and 3D). The headphones graphic 52, the microphone graphic 54, and the radiating concentric circles 56 serve as visual cues of the states of the communicant's sound playback and microphone devices. The on or off state of a communicant's text chat channel is depicted by the presence or absence of a hand graphic 57 adjacent the communicant's sprite (as shown in FIG. 3D). When a communicant is transmitting text chat data to another network node the hand graphic 57 is present, and when a communicant is not transmitting text chat data the hand graphic 57 is not present. In some embodiments, text chat data is transmitted only when keyboard keys are depressed, in which case the visualization of the communicant's text channel appears as a flashing on and off of the hand graphic 57.

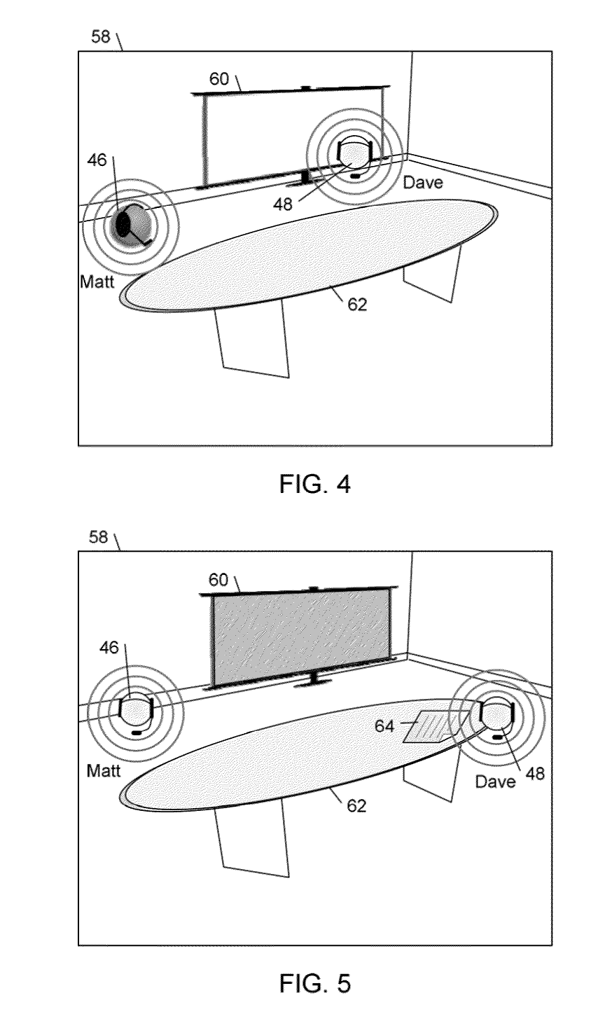

FIGS. 4 and 5 respectively show embodiments of spatial visualizations of a realtime communication session that include visual cues that reveal the current communication states of two networked communicants involved in the realtime communication session in relation to props (also referred to as objects) in a graphical representation of a virtual area. In these embodiments, the spatial visualization includes a graphical representation 46, 48 of each of the communicants in spatial relation to a graphical representation 58 of a virtual area. In particular, the virtual area is represented by a perspective view of a three-dimensional visual space in which the graphical representations 46, 48 of the communicants can have different respective positions. The visualizations shown in FIGS. 4 and 5 also include props that provide visual cues that reveal the states of various communication channels over which the communicants are configured to communicate. In particular, these visualizations include a viewscreen 60 that shows the state of application sharing communication sessions, and a table 62 that shows the state of file sharing communication sessions.

The viewscreen 60 provides visual cues that indicate whether or not a communicant is sharing an application over an application sharing channel. As shown in FIG. 4, in response to a communicant's selection of the viewscreen 60, the communicant's sprite 48 automatically is moved to a position in the graphical representation 58 of the virtual area that is adjacent the viewscreen 60. The position of the communicant's sprite 48 adjacent the viewscreen 60 indicates that the communicant currently is sharing or is about to share an application with the other communicants in the virtual area. The graphical depiction of viewscreen 60 is changed depending on whether or not an active application sharing session is occurring. In the illustrated embodiment, the depicted color of the viewscreen 60 changes from light during an active application sharing session (as shown in FIG. 4) to dark when there is no application sharing taking place (as shown in FIG. 5). Additional details regarding the application sharing process are described in connection with FIGS. 26-28 of U.S. patent application Ser. No. 12/354,709, filed Jan. 15, 2009, and in U.S. patent application Ser. No. 12/418,270, filed Apr. 3, 2009.

The table 62 provides visual cues that indicate whether or not a communicant is sharing or has shared a data file over a data file sharing channel. As shown in FIG. 5, in response to a communicant's selection of the table 62, the communicant's sprite 48 automatically is moved to a position in the graphical representation 58 of the virtual area that is adjacent the table 62. The position of the communicant's sprite 48 adjacent the viewscreen 60 indicates that the communicant currently is sharing or is about to share a data file with the other communicants in the virtual area. In this process, the communicant uploads the data file from the client node 12 to a repository that is maintained by the synchronous conferencing server node 30. In response to the communicant's selection of the data file to upload, the synchronous conferencing server node 30 stores the uploaded file in the repository and creates a database record that associates the data file with the table 62. After a data file has been shared by the communicant, the state of the table 62 changes from having a clear table surface (as shown in FIG. 4) to having a graphical representation 64 of a data file on the table surface (as shown in FIG. 5). Other communicants in the virtual area 58 are able to view the contents of the uploaded data file by selecting the graphical representation 64 and, subject to governance rules associated with the virtual area 58, optionally may be able to modify or delete the data file. Additional details regarding the file sharing process are described in connection with FIGS. 22 and 23 of U.S. patent application Ser. No. 12/354,709, filed Jan. 15, 2009.

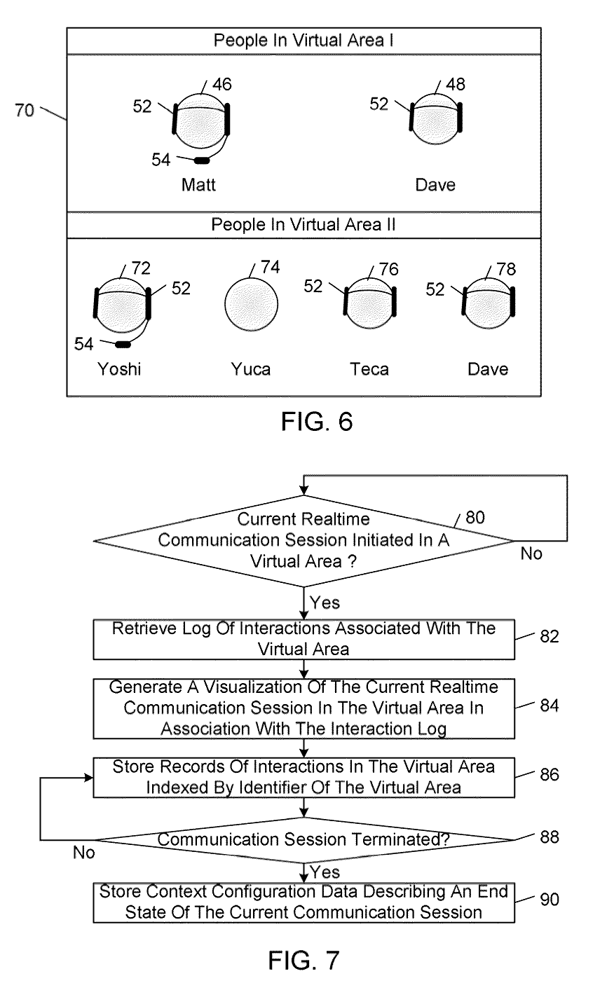

FIG. 6 shows an embodiment of a spatial visualization 70 of two realtime communication sessions in two different virtual areas (i.e., “Virtual Area I” and “Virtual Area II”). Each of the virtual areas is represented by a one-dimensional space that contains graphical representations of the communicants who currently have presence in the space. In some embodiments, the ordering of the spatial positions (e.g., from left to right) of the graphical representations of the communicants in each of the virtual areas corresponds to a spatial visualization of the temporal ordering of the communicants in terms of the times when they established respective presences in the virtual areas. In the illustrated embodiments, each communicant is represented by a respective circular sprite 46, 48, 72, 74, 76, 78. The communicant named “Dave” is represented by a respective sprite 48, 78 in each of the virtual areas, reflecting the fact that he is present in both virtual areas. The states of various communication channels over which the respective communicant is configured to communicate are revealed by visual cues that are shown in the spatial visualization 70. For example, the on or off state of a communicant's local speaker channel is depicted by the presence or absence of a headphones graphic 52 on the communicant's sprite. Thus, when the speakers of the communicant who is represented by the sprite are on, the headphones graphic 52 is present (see sprites 46, 48, 72,76, and 78) and, when the communicant's speakers are off, the headphones graphic 52 is absent (see sprite 74). The on or off state of the communicant's microphone is depicted by the presence or absence of a microphone graphic 54 on the communicant's sprite. Thus, when the microphone is on, the microphone graphic 54 is present (see sprites 46 and 72) and, when the microphone is off, the microphone graphic 54 is absent (see sprites 48, 74, 78, and 78). In this way, the headphones graphic 52 and the microphone graphic 54 provide visual cues of the states of the communicant's sound playback and microphone devices.

### III. INTEGRATING SPATIAL VISUALIZATIONS WITH LOGS OF REALTIME NETWORKED INTERACTIONS IN A VIRTUAL AREA

A. Introduction

Embodiments of the platform are capable of integrating a spatial visualization of realtime networked communications in a virtual area with logs of the interactions that are associated with the virtual area. In this way, current and prior logs of communicant interactions are enhanced with references to the spatial visualization of those interactions, references which engage the communicants' spatial memories of the interactions to enable greater recall and understanding of the contexts of the interactions.

In some embodiments, a current realtime communication session is established between communicants operating on respective network nodes. A spatial visualization of the current realtime communication session is displayed on a display. The spatial visualization includes a graphical representation of each of the communicants in spatial relation to a graphical representation of a virtual area. During the current communication session, a log of event descriptions describing respective events involving interactions of the communicants in the virtual area is presented on the display in contextual association with elements of the spatial visualization of the current realtime communication session.

In some embodiments, a visual association between respective ones of the event descriptions in the log and elements of the spatial visualization of the current realtime communication session is depicted on the display. For example, a visual association may be depicted between respective ones of the event descriptions in the log and respective ones of the graphical representations of the communicants involved in the events described by the respective event descriptions. In this example, a respective label may be associated with each of one or more of the event descriptions, where the label has a respective visual appearance that matches a visual element of the graphical representation of the communicant involved in the event described by the event description. In this way, the events in the log share a common visual vocabulary with the state of the communicants in the spatial visualization shown in the display.

In some embodiments, in response to an entry of a respective one of the communicants into the virtual area, the graphical representation of the respective communicant is added to the spatial visualization, and a respective one of the event descriptions describing the entry of the respective communicant into the virtual area is presented on the display. In some embodiments, in response to a departure of a respective one of the communicants from the virtual area, the graphical representation of the respective communicant is removed from the spatial visualization, and a respective one of the event descriptions describing the departure of the respective communicant from the virtual area is presented on the display. In some embodiments, in response to a sharing of a data file by a respective one of the communicants with other ones of the communicants, a communicant-selectable graphical representation of the data file is displayed in spatial relation to the graphical representation of the virtual area, and a respective one of the event descriptions describing the sharing of the data file by the respective communicant is presented on the display. In some embodiments, in response to a sharing of an application by a respective one of the communicants with other ones of the communicants, a graphical indication of the sharing of the application in spatial relation to the graphical representation of the virtual area is displayed on the display, and a respective one of the event descriptions describing the sharing of the application by the respective communicant is displayed on the display.

FIG. 7 shows an embodiment of a method by which the platform integrates spatial visualizations of realtime networked interactions in a virtual area with historical records of the interactions that are associated with the virtual area.

In response to the initiation of a current realtime communication session in a virtual area (FIG. 7, block 80), the platform retrieves context configuration data that includes a log of interactions that are associated with the virtual area (FIG. 7, block 82). The log typically includes data that is extracted from the interaction records 38, which describe the contexts of interactions between communicants in the virtual area. The extracted data may include, for example, data stream data (e.g., text chat entries) and references (e.g., hyperlinks) to files and data streams (e.g., audio and video data streams) that are shared or recorded during one or more prior communication sessions in the virtual area.

The platform generates a visualization of the current realtime communication session in the virtual area in association with the historical log (FIG. 7, block 84). In this process, the platform typically retrieves context data describing an end state of the preceding communications session in the virtual area, including the positions and states of the props in the virtual area. The spatial visualization that is generated includes a graphical representation of each of the communicants in spatial relation to a graphical representation of the virtual area. The virtual area may be represented graphically by any type of one-dimensional, two-dimensional, or three-dimensional view that situates the graphical representations of the communicants in respective positions in a visual space. During the current communication session, the platform depicts visual cues in the spatial visualization that shows current communication states of the communicants. Each of the communication states typically corresponds to a state of a respective communication channel (e.g., text chat, audio, video, application share, and file share channel) over which a respective one of the communicants is configured to communicate.

During the current realtime communication session, the platform stores context configuration data that includes records of interactions between the communicants that occur in the virtual area, where the records are indexed by an identifier of the virtual area (FIG. 7, block 86). Each interaction record describes the context of an interaction between a pair of the communicants in the virtual area. For example, in some embodiments, an interaction record contains an identifier for each of the communicants, an identifier for the place of interaction (e.g., a virtual area instance), a description of the hierarchy of the interaction place (e.g., a description of how the interaction area relates to a larger area), start and end times of the interaction, and a list of all files and other data streams that are shared or recorded during the interaction. Thus, for each realtime interaction, the interaction platform tracks when it occurred, where it occurred, and what happened during the interaction in terms of communicants involved (e.g., entering and exiting), objects that are activated/deactivated, and the files that were shared.

In response to the termination of the current communication session (FIG. 7, block 88), the platform stores context configuration data that describes the end state of the current communication session (FIG. 7, block 90). The end state context configuration data typically includes a description of all props (e.g., viewscreen and table props) that are present in the virtual area at the time the current communication session was terminated, including a description of the positions of the props and their respective states (e.g., associations between a table prop and data files that were shared in the virtual area). The end state context configuration data typically is used by the platform to recreate the end state of the virtual area for the next realtime communication session that takes place in the virtual area.

B. Exemplary Spatial Interfaces for Realtime Chat Interactions

Some embodiments apply one or more of the spatial metaphor visualizations described above on top of realtime chat interactions. These visualizations provide a context for depicting the current communication states of the communicants involved in realtime chat interactions. The spatial metaphor also provides a context for organizing the presentation of various interface elements that are used by communicants to participate in realtime chat interactions. The spatial metaphor visualizations may be applied to any type of instant messaging platform that provides realtime text-based communication between two or more communicants over the internet or some form of internal network/intranet, optionally with one or more other realtime communication channels, such as audio, video, file share, and application sharing channels. For example, embodiments may be integrated with any of the currently available instant messaging platforms including, for example, AOL Instant Messenger, MSN Messenger, Yahoo! Messenger, Google Talk, and Skype.

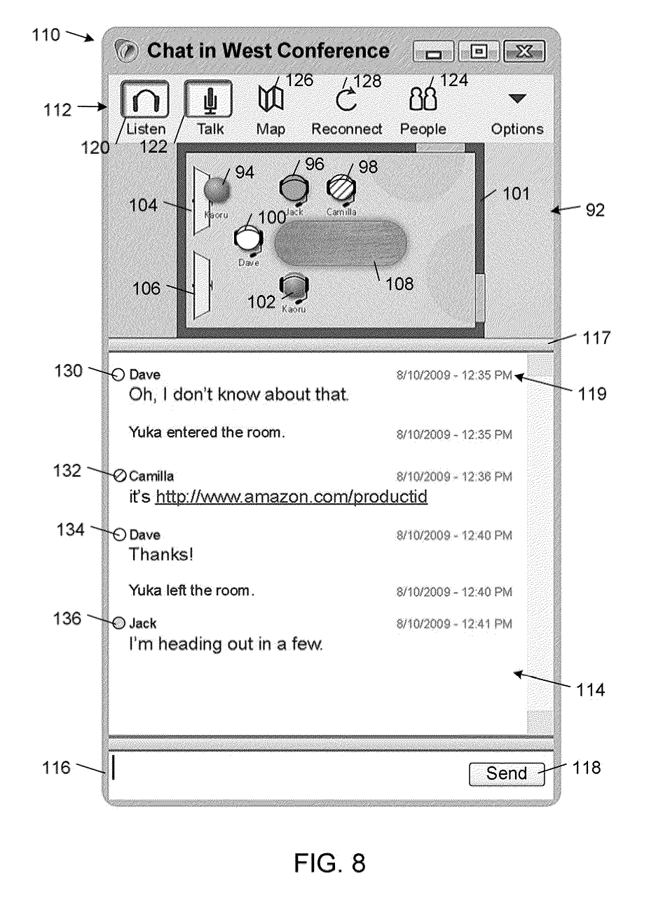

FIG. 8 shows an exemplary embodiment of a spatial interface 92 for a realtime chat interaction between a group of communicants in a virtual area. Each of the communicants is represented graphically by a respective sprite 94, 96, 98, 100, 102 and the virtual area is represented graphically by a two-dimensional top view of a rectangular space 101 (i.e., the “West Conference” space). When the communicants initially enter the virtual area, their sprites automatically are positioned in predetermined locations (or “seats”) in the virtual area. The virtual area includes two viewscreen props 104, 106 and a table prop 108. Communicants interact with the props by selecting them with a input device (e.g., by double-clicking on the props with a computer mouse, touch pad, touch screen, or the like).

The spatial interface 92 is integrated with a realtime communications interface window 110 that also includes a toolbar 112, a chat log area 114, a text box 116, and a Send button 118. The user may enter text messages in the text box 116 and transmit the text messages to the other communicants in the currently West Conference space 101 by selecting the Send button 118. The spatial interface 92 and the chat log area 114 are separated by a splitter 117 that, in some embodiments, can be slid up and down by the user to hide or reveal the spatial interface 92.

The chat log area 114 displays a log of current and optionally prior events that are associated with the West Conference space 101. An exemplary set of events that are displayed in the chat log area 114 include: text messages that the user has exchanged with other communicants in the West Conference space 101; changes in the presence status of communicants in the West Conference space 101; changes in the speaker and microphone settings of the communicants in the West Conference space 101; and the status of the props 104-108, including references to any applications and data files that are shared in connection with the props. In the illustrated embodiments, the events are labeled by the communicant's name followed by content associated with the event (e.g., a text message) or a description of the event. For example, in the example shown in FIG. 8, status related events are labeled as follows:

$UserName$ entered the room.

$UserName$ left the room.

$UserName$ shared $ProcessName$ on $ViewScreenName$.

$UserName$ cleared $ViewScreenName$

where the tags between “$” and “$” identify communicants, shared applications, or props. In addition, each of the events is associated with a respective timestamp 119 that identifies the date and time when the associated event was initiated.

In embodiments that are integrated with conventional instant messaging platforms (e.g., AOL Instant Messenger, MSN Messenger, Yahoo! Messenger, Google Talk, and Skype), the chat log area 114 typically contains a standard “chat history” (also referred to as an “instant message history”) that includes a list of entries typed remotely by two or more networked communicants, interleaved in the order the entries have been typed. The chat history typically is displayed on each communicant's terminal display, along with an indication of which user made a particular entry and at what time relative to other communicant's entries. This provides a session history for the chat by enabling communicants to independently view the entries and the times at which each entry was made.

The spatial visualization 92 provides a context for organizing the presentation of the events that are displayed in the chat log area 114. For example, in the illustrated embodiment, each of the displayed events is labeled with a respective tag that visually correlates with the appearance of the sprite of the communicant that sourced the displayed event. In particular, each of the events that is sourced by a particular one of the communicants is labeled with a respective icon 130, 132, 134, 136 with a visual appearance (e.g., color-code) that matches the visual appearance of that communicant's sprite. In this example, the color of the icons 130, 134 matches the color of the body of Dave's sprite 100, the color of the icon 132 matches the color of the body of Camilla's sprite 98, and the color of the icon 136 matches the color of the body of Jack's sprite 96.

The toolbar 112 includes a set of navigation and interaction control buttons, including a headphones button 120 for toggling on and off the user's speakers, a microphone button 122 for toggling on and off the user's microphone, a get button 124 for getting people, a map button 126 for opening a map view of a larger virtual area the contains the space 101, and a reconnect button 128 for reestablishing a connection to the virtual area.

After the user has moved into the West Conference space 101, the user may toggle one or both of the headphones button 120 and the microphone button 122 in order to selectively turn-on and turn-off one or both of the user's speakers and microphone. As explained above, the headphones graphic, the radiating concentric circles around the user's sprite, and the microphone graphic on the user's sprite are omitted when the user's speakers and microphone both are turned-off.

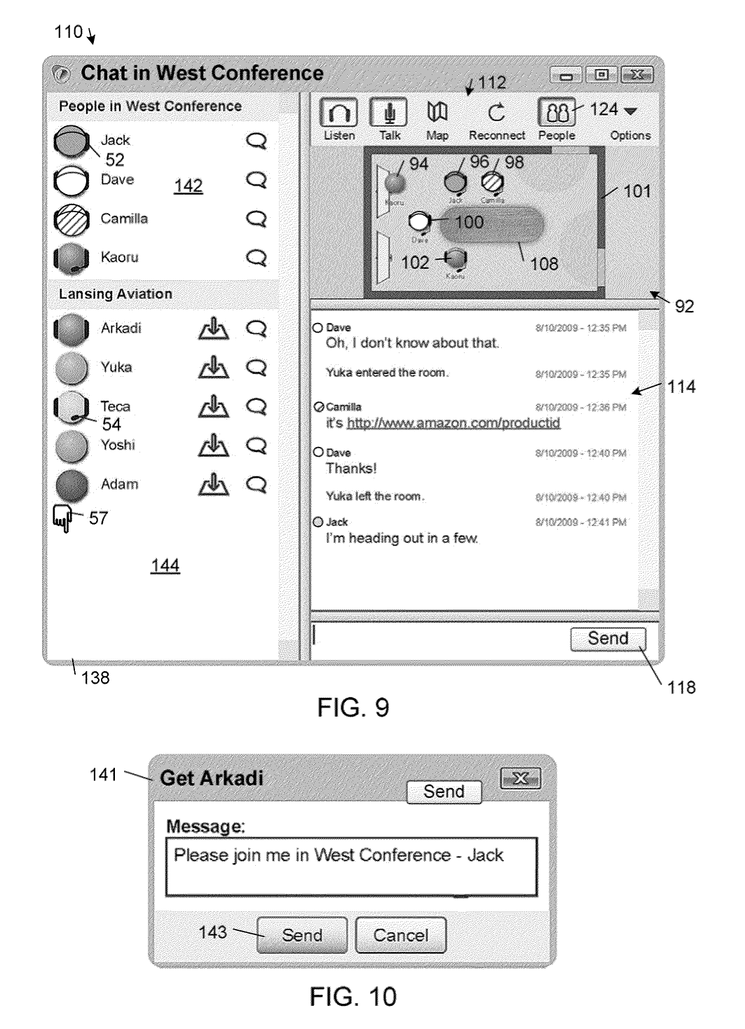

Referring to FIG. 9, in response to a user selection of the get button 124, a list of communicants is displayed in a separate frame 138. The communicants are segmented into two groups: a first group labeled “People in West Conference” that identifies all the communicants who are in the current area (i.e., West Conference); and a second group labeled “Lansing Aviation” that identifies all the communicants who are present in a larger area (i.e., Lansing Aviation, which contains the current area) but are not present in the current area. Each of the virtual areas is represented by a respective one-dimensional space 142, 144 that contains graphical representations of the communicants who currently have presence in the space. In some embodiments, the ordering of the spatial positions (e.g., from top to bottom) of the graphical representations of the communicants in each of the virtual areas 142 144 corresponds to a spatial visualization of the temporal ordering of the communicants in terms of the times when they established respective presences in the virtual areas. In the illustrated embodiments, each communicant is represented by a respective circular sprite that is labeled with a respective user name of the communicant (i.e., “Jack,” “Dave,” “Camilla,” “Karou,” “Arkadi,” “Yuka,” “Teca,” “Yoshi,” and “Adam”).

The states of various communication channels over which the respective communicant is configured to communicate are revealed by visual cues that are shown in the spatial visualizations of the communicants in the virtual areas 142, 144. For example, the on or off state of a communicant's local speaker channel is depicted by the presence or absence of a headphones graphic 52 on the communicant's sprite. Thus, when the speakers of the communicant who is represented by the sprite are on, the headphones graphic 52 is present (see sprites Jack, Dave, Camilla, Karou, Arkadi, and Teca) and, when the communicant's speakers are off, the headphones graphic 52 is absent (see sprites Yuka, Yoshi, and Adam). The on or off state of the communicant's microphone is depicted by the presence or absence of a microphone graphic 54 on the communicant's sprite. Thus, when the microphone is on, the microphone graphic 54 is present (see sprites Karou and Teca) and, when the microphone is off, the microphone graphic 54 is absent (see sprites Jack, Dave, Camilla, Arkadi, Yuka, Yoshi, and Adam). (The radiating circles that indicate the on state of a communicant's microphone graphic typically is omitted in this visualization.) The headphones graphic 52 and the microphone graphic 54 provide visual cues of the states of the communicant's sound playback and microphone devices. The activity state of a communicant's text chat channel is depicted by the presence or absence of the hand graphic 57 adjacent the communicant's sprite (see sprite Adam). Thus, when a communicant is transmitting text chat data to another network node the hand graphic 57 is present, and when a communicant is not transmitting text chat data the hand graphic 57 is not present. In some embodiments, text chat data is transmitted only when keyboard keys are depressed, in which case the visualization of the communicant's text channel appears as a flashing on and off of the hand graphic 57.

In response to a user selection of one of the communicants in the list of available communicants in the frame 138, the platform transmits an invitation to the selected communicant to join the user in the respective zone. For example, FIG. 10 shows a pop-up window 141 that is generated by the platform in the situation in which the user has selected “Arkadi” in the list of available communicants displayed in the frame 138. In response to the selection of the Send button 143, the platform transmits an invitation to the communicant who is associated with the name Arkadi to join the user in the West Conference space 101 (e.g., “Please join me in West Conference—Jack.”).

C. Exemplary Spatial Interfaces for Private Realtime Networked Interactions

Some embodiments apply one or more of the spatial metaphor visualizations described above on top of realtime private interactions between (typically only two) networked communicants. These spatial visualizations enable the depiction of a current private realtime communications session between the communicants in the context of their prior private relationship history. In other words, the semantics of the virtual area is the relationship history between the communicants. The spatial visualizations also provide a framework for organizing the presentation of various interface elements that are used by communicants to participate in private realtime networked communications in the context of their prior relationship history.

A current private realtime communications session between communicants typically is visualized as a private virtual area that provides a reference for the records of the private interactions that occur in the private virtual area, records which are stored persistently in the relationship database 36 in association with the private virtual area. The virtual area typically is created automatically during the first communication session and then persists until one or all of the communicants choose to delete it. By default, the private virtual area typically is owned jointly by all the participating communicants. This means that any of the communicants can freely access the private virtual area and the associated private interaction records, and can unilaterally add, copy, or delete the private virtual area and all the associated private interaction records.

Each communicant typically must explicitly navigate to the private virtual area that he or she shares with another communicant. In some embodiments, this is achieved by selecting an interface control that initiates a private communication with the other communicant. For example, in some embodiments, in response to the initiating of a private instant messaging communication (e.g., a text, audio, or video chat) with another communicant, the platform automatically situates the private communication in a private virtual area that typically is configured in accordance with configuration data that describes the prior state of the private virtual area when the communicants last communicated in the private virtual area.

In some embodiments, the platform responds to the receipt of a command from a first communicant operating on a first network node to initiate a private communication with a second communicant operating on a second network node as follows. The platform establishes a current realtime communication session between the first and second network nodes. The platform identifies a private virtual area that is associated with the first and second communicants. The platform retrieves context configuration data associated with the private virtual area and generated in response to interactions of the first and second communicants in the private virtual area. On a display, the platform displays a spatial visualization of the current realtime communication session, where the spatial visualization includes graphical representations of the first and second communicants in spatial relation to a graphical representation of the virtual area configured in accordance with the context configuration data.

In some embodiments, during the current realtime communication session, the platform generates a log of event descriptions describing respective events involving interactions of the first and second communicants in the virtual area. During the current realtime communication session, platform typically stores the event descriptions in a data storage device with an index comprising an identifier of the virtual area. The log of event descriptions may include, for example, at least one of: text of a chat conversation between the first and second communicants in the virtual area; a description of a data file shared by a respective one of the first and second communicants in the virtual area; and a description of an application shared by a respective one of the first and second communicants in the virtual area. During the current realtime communication session, typically presents the log of event descriptions on the display. The log of event descriptions typically is presented in contextual association with elements of the spatial visualization of the current realtime communication session.

In some embodiments, the platform retrieves context configuration data that includes a log of event descriptions describing respective events involving interactions of the first and second communicants in the virtual area during one or more prior communication sessions before the current communication session. The platform typically presents the log of event descriptions generated during the current realtime communication session together with the retrieved context configuration data comprising the log of event descriptions.

In some embodiments, the platform retrieves context configuration data that includes a description of an end state of a prior realtime communication session between the communicants and displays the graphical representation of a virtual area in a state that corresponds to the end state of the prior communication session between the communicants.

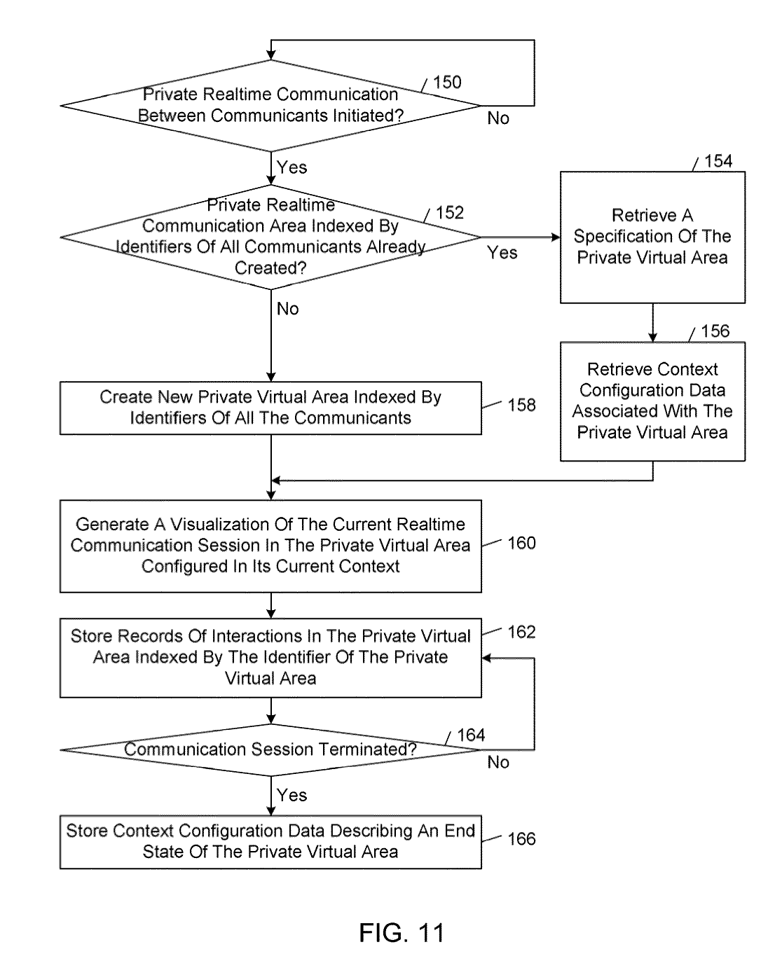

FIG. 11 shows an embodiment of a method of managing realtime networked communications between networked communicants in a private virtual area. In response to a determination that a private realtime communication between communicants has been initiated (FIG. 11, block 150), the platform determines whether or not a private virtual area that is indexed by the identifiers of all the communicants already has been created (FIG. 11, block 152). If such a private virtual area already has been created, the platform retrieves a specification of the private virtual area (FIG. 11, block 154); the platform also, retrieves context configuration data that is associated with the private virtual area (FIG. 11, block 156). If a private virtual area that is indexed by the identifiers of all the communicants has not already been created, the platform creates a new private virtual area that is indexed by identifiers of all the communicants (FIG. 11, block 158). After the specification of the private virtual area has been either retrieved or newly created, the platform generates a visualization of the current realtime communication session in the private virtual area configured in its current context (i.e., either in its prior configuration or in its new default configuration) (FIG. 11, block 160). During the current private realtime communication session, the platform stores context configuration data that describes the state of the private virtual area and includes records of interactions in the private virtual area, which records are indexed by the identifier of the private virtual area (FIG. 11, block 162).

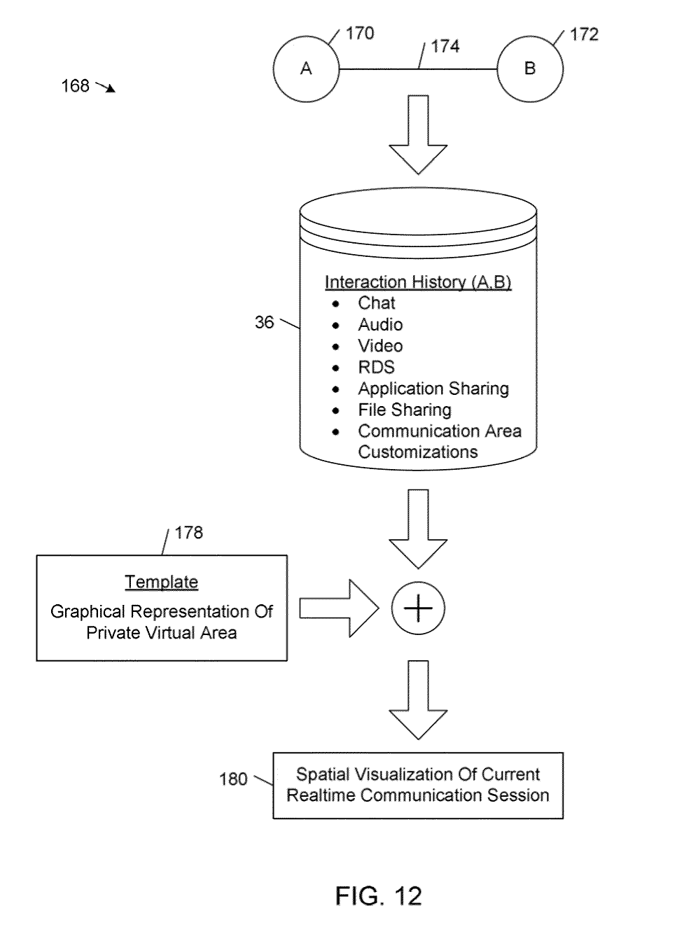

FIG. 12 shows an embodiment of a process 168 of generating a spatial visualization of a current realtime communication session. In this process, each of the communicants (A and B) is represented by a respective node 170, 172 and their private bilateral relationship is represented by an edge 174 of a graph that interconnects the nodes 170, 172. The bilateral relationship between the communicants is defined by their interaction history in the private virtual area. The interaction history is stored in the interaction database 36 in the form of interaction records that describe the interactions of the communicants in the private virtual area. These interactions can include any of the interactions involving any of the communication channels over which the communicants are configured to communicate, including, for example, chat, audio, video, realtime differential streams of tagged records containing configuration instructions, 3D rendering parameters, and database query results (e.g., streams keyboard event streams relating to widget state changes, mouse event streams relating to avatar motion, and connection event streams), application sharing, file sharing, and customizations to the private virtual area. In the illustrated embodiment, the interaction history between the communicants is integrated with a template 178 that describes a graphical representation of the private virtual area to produce the spatial visualization 180 of the current realtime communication session. In this process, the private virtual area is configured in accordance with the customization records in the interaction history. The private virtual area also is populated with the other elements of the interaction history in accordance with the specification provided by the template 178.

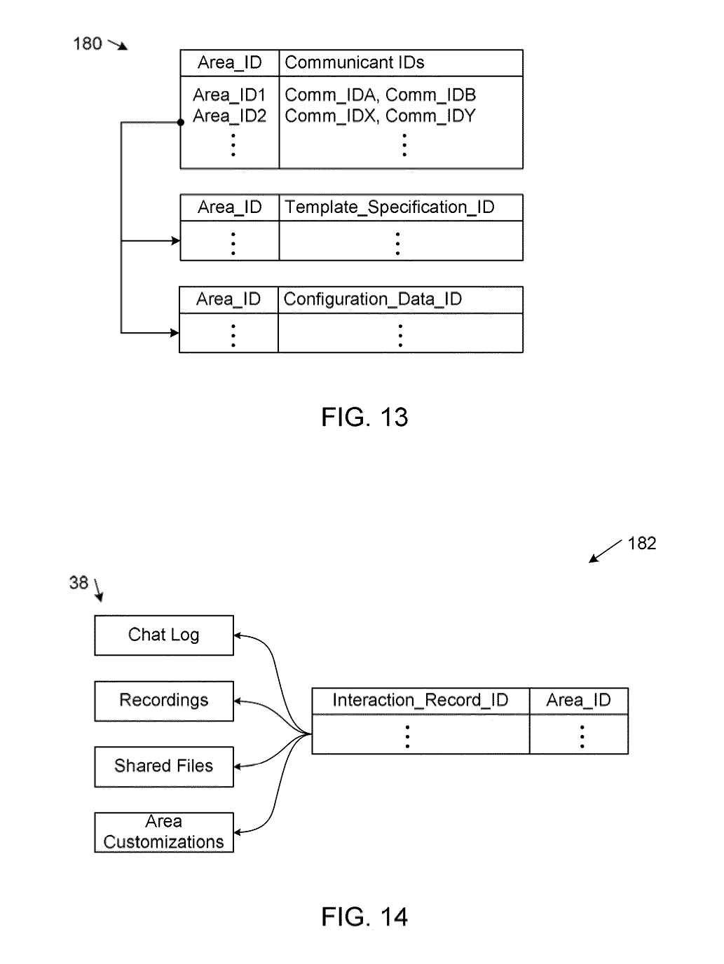

FIG. 13 shows an embodiment of a data model 180 that relates private virtual area identifiers to communicants, template specifications, and context data. In accordance with this data model 180, each private virtual area is associated with a respective unique identifier (e.g., Area_ID1 and Area_ID2) and is indexed by the respective identifiers (e.g., Comm_IDA, Comm_IDB, Comm_IDX, and Comm_IDY) of all the communicants who own the private virtual area. In the examples shown in FIG. 13, each of the private virtual areas is jointly owned by a respective pair of communicants. Each area identifier is associated with a respective template specification identifier that uniquely identifies a particular area specification. Each area identifier also is associated with a respective configuration data identifier that uniquely identifies a particular set of data (e.g., customization data) that is used by the platform to configure the private virtual area.

FIG. 14 shows an embodiment of a data model 182 that relates interaction records 38 in the relationship database 36 with respective ones of the private virtual areas. This relationship is used by the platform in the process of populating the private virtual area with the elements of the interaction history in accordance with the associated template specification.

FIGS. 15 and 16 show an embodiment of a spatial interface 188 for realtime networked communications between communicants in a private virtual communication area (labeled “Chat with Dave”) that is created by the platform for the private bilateral interactions between the user (i.e., Jack) and another communicant (i.e., Dave). FIG. 15 depicts an exemplary state of the private virtual area in which Dave left the area after having just interacting with Jack, who still is in the private virtual area. FIG. 16 depicts the state of the private virtual area in which Jack just entered the area, which already was occupied by Dave.

The spatial interface 188 provides a spatial visualization of the private virtual area. In this visualization, each of the communicants is represented graphically by a respective sprite 196, 198 and the private virtual area is represented graphically by a 2.5-dimensional iconographic view of a cloud. The iconographic cloud view distinguishes the private virtual area from other types of virtual areas in a way that reinforces the notion that the focus of the private virtual area, first and foremost, is the relationship between the communicants as opposed to the area. In contrast, other types of virtual areas (e.g., West Conference), the central focus typically relates to matters that traditionally are associated with real-world physical spaces (e.g., work, home, meetings, clubs, etc.).

When the communicants initially enter the private virtual area, their sprites automatically are positioned in predetermined locations (or “seats”) in the private virtual area. In the illustrated embodiment, the private virtual area includes a viewscreen prop 200. In this embodiment, in response to the selection of the viewscreen object 200, the graphical representation of a communicant is repositioned adjacent to the viewscreen object and a pair of eyes is added to the graphical representation to provide an additional visual indication that the associated communicant is viewing an application in connection with the viewscreen object 200.

The communicants that are associated with the private virtual area may customize the private virtual area, for example, by adding additional props (e.g., another viewscreen prop or a table prop), changing the color scheme, etc. Communicants interact with the props by selecting them with a input device (e.g., by double-clicking on the props with a computer mouse, touch pad, touch screen, or the like). In response to a communicant's selection of a particular prop, the communicant's sprite either is repositioned adjacent to the selected prop or it is replicated and the replicated sprite is positioned adjacent to the selected prop and the original sprite remains where it was seated.

The spatial interface 188 is integrated with a realtime communications interface window 190 that additionally includes a toolbar 192, a chat log area 194, a text box 206, and a Send button 208 that function in the same way as the toolbar 112, the chat log area 114, the text box 116, and the Send button 118 of the spatial interface 110 shown in FIG. 8.

The chat log area 194 displays a log of events that are associated with the private bilateral interactions between the user (i.e., Jack) and another one of the communicants (i.e., Dave). The log of events includes sequences of text messages that the user has exchanged with the other communicant in the associated private virtual area. The user may enter text messages in the text box 206 and transmit the text messages to the other communicant in the private virtual area by selecting the Send button 208. An exemplary set of events that can be recorded in the chat log area 204 include: text message entries; changes in the presence status of communicants in the private virtual area; changes in the speaker and microphone settings of the communicants in the private virtual area; and the status of any props (e.g., viewscreen 200), including references to any applications and data files that are shared in connection with the props.

In the illustrated embodiments, the events are labeled by the communicants' names followed by content associated with the event (e.g., a text message) or a description of the event. In FIGS. 15 and 16, status related events are labeled as follows:

$UserName$ entered the room.

$UserName$ left the room.

$UserName$ shared $ProcessName$ on $ViewScreenName$.

$UserName$ cleared $ViewScreenName$

where the tags between “$” and “$” identify communicants, shared applications, or props. In addition, each of the events is associated with a respective timestamp 209 that identifies the date and time of the associated event. In another example, the application sharing event description 214 has a description of the event class (Share), the identity of the sharer (Dave), the label of the share target (Screen 1), the URL of the share target (represented by the underlining of the share target label), the timestamp associated with the event, and a description of the shared application.

As shown in FIG. 16, a graphical separator, such as rule line 216, is added to the chat log area 194 between the events of one communication session (also referred to as a “conversation”) and those of another communication session. In some embodiments, the textual descriptions of prior communication sessions are deemphasized (e.g., by using a lighter font color, such as gray) so that the events that area associated with the current communication session stand out visually.

In some embodiments, previous conversations are “collapsed” and labeled with the list of participants in the conversation as well as a timestamp of the most recent event or message within the conversation. Clicking a “toggle” to the left of the conversation label opens up the conversation and displays the full contents of the conversation in the chat log area 194.

In embodiments that are integrated with conventional instant messaging platforms (e.g., AOL Instant Messenger, MSN Messenger, Yahoo! Messenger, Google Talk, and Skype), the chat log area 194 contains a standard “chat history” (also referred to as an “instant message history”) that includes a list of entries typed remotely by two or more networked communicants, interleaved in the order the entries have been typed. The chat history typically is displayed on each communicant's terminal display, along with an indication of which user made a particular entry and at what time relative to other communicant's entries. This provides a session history for the chat by enabling communicants to independently view the entries and the times at which each entry was made.

The spatial interface 188 provides a context for organizing the presentation of the events that are displayed in the chat log area 194. For example, in the illustrated embodiment, each of the displayed events is labeled with a respective tag that visually correlates with the appearance of the sprite of the communicant that sourced the displayed event. In particular, each of the events that is sourced by a particular one of the communicants is labeled with a respective icon 210, 212 with a visual appearance (e.g., color-code) that matches the visual appearance of that communicant's sprite. In the illustrated embodiment, for example, the color of the icon 212 matches the color of the body of Dave's sprite 198 and the color of the icon 210 matches the color of Jack's sprite 196.

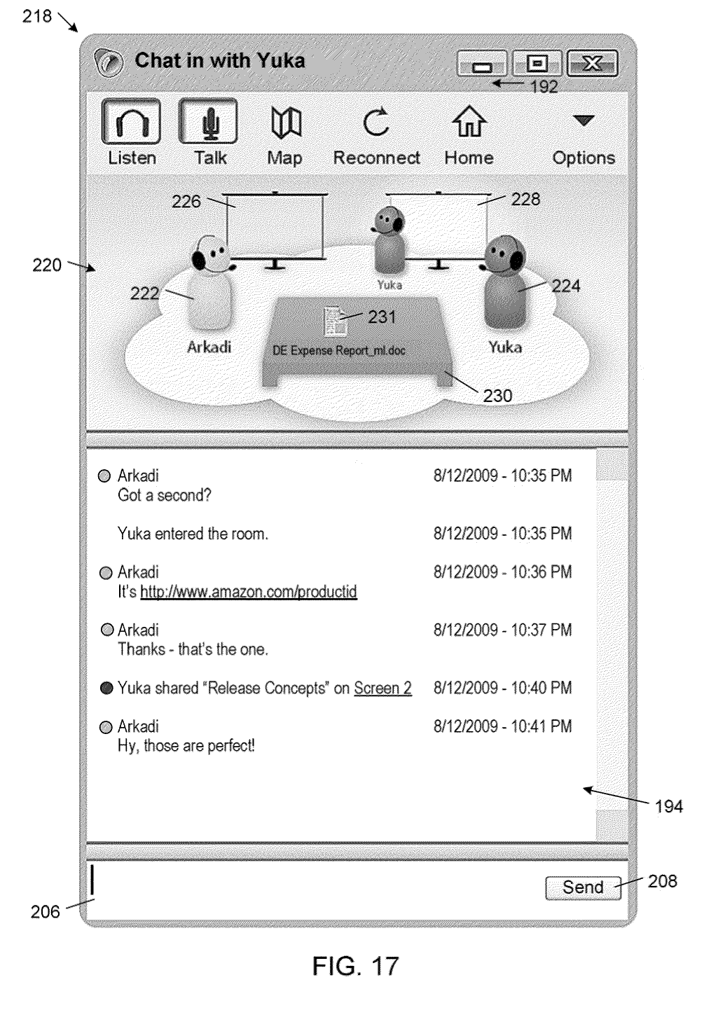

FIG. 17 shows an embodiment of a spatial interface 220 for realtime networked communications between communicants in a private virtual area (labeled “Chat with Yuka”) that is created by the platform for the private bilateral interactions between the user (i.e., Arkadi) and another communicant (i.e., Yuka). The spatial interface 220 provides a spatial visualization of the private virtual area. In this visualization, each of the communicants is represented graphically by a respective sprite 222, 224 and the virtual area is represented graphically by a 2.5-dimensional iconographic view of a cloud. The spatial interface 220 is integrated with a realtime communications interface window 218 that additionally has the same interface elements as the interface window 190 shown in FIGS. 15 and 16, including a toolbar 192, a chat log area 194, a text box 206, and a Send button 208.

When the communicants initially enter their private virtual area, their sprites automatically are positioned in predetermined locations (or “seats”) in the private virtual area. In the illustrated embodiment, the private virtual area includes two viewscreen props 226, 228 and a table prop 230, on top of which is shown a graphical representation 231 of a data file (i.e., “DE Expense Report_ml.doc”) that was shared by a respective one of the communicants. The communicants that are associated with the private virtual area may customize the private virtual area, for example, by adding additional props (e.g., another viewscreen prop or a table prop), changing the color scheme, etc. Communicants interact with the props by selecting them with an input device (e.g., by double-clicking on the props with a computer mouse, touch pad, touch screen, or the like). In response to a communicant's selection of a particular prop, the communicant's sprite either is repositioned adjacent to the selected prop or it is replicated and the replicated sprite is positioned adjacent to the selected prop and the original sprite remains where it was seated. In the example shown in FIG. 17, Yuka has selected the viewscreen 228 and, in response, the platform has created a copy 232 of her original sprite 224 at a location adjacent the selected viewscreen 228. While an application (or process) is being shared, the viewscreen 228 is shown to be in an active state, which is visually distinguishable from the depiction of the inactive viewscreen 226.

### IV. EXEMPLARY SYSTEM ARCHITECTURE

### A. Introduction

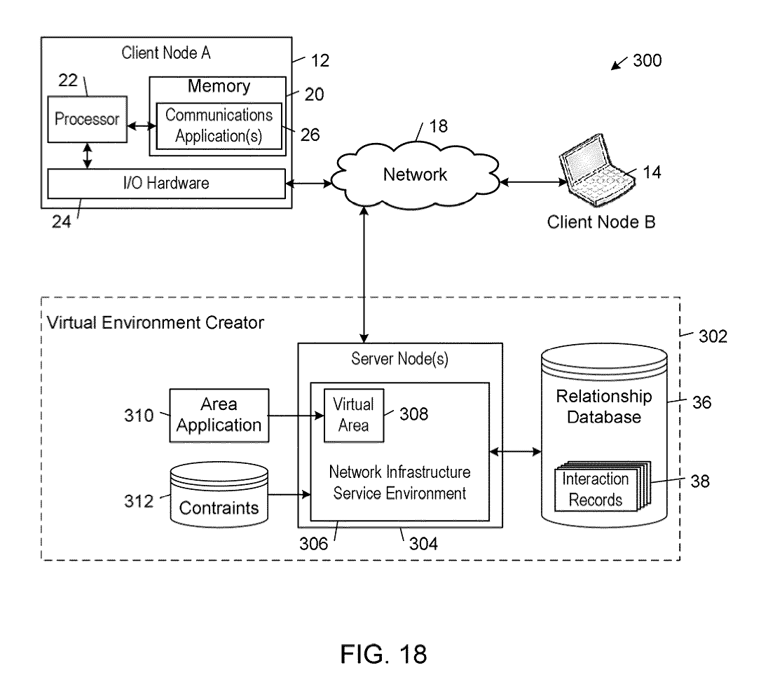

FIG. 18 is a diagrammatic view of an embodiment 300 of the network communication environment 10 (see FIG. 1) in which the synchronous conferencing server node 30 is implemented by a virtual environment creator 302. The virtual environment creator 302 includes at least one server network node 304 that provides a network infrastructure service environment 306. The communications application 26 and the network infrastructure service environment 306 together provide a platform for creating a spatial virtual communication environment (also referred to herein simply as a “virtual environment”) that includes one or more of the spatial metaphor visualizations described above.

The network infrastructure service environment 306 manages sessions of the first and second client nodes 12, 14 in a virtual area 308 in accordance with a virtual area application 310. The virtual area application 310 is hosted by the virtual area 308 and includes a description of the virtual area 308. The communications applications 26 operating on the first and second client network nodes 12, 14 present respective views of the virtual area 308 in accordance with data received from the network infrastructure service environment 306 and provide respective interfaces for receiving commands from the communicants and providing a spatial interface that enhances the realtime communications between the communicants as described above. The communicants typically are represented in the virtual area 308 by respective avatars, which typically move about the virtual area 308 in response to commands that are input by the communicants at their respective network nodes. Each communicant's view of the virtual area 308 typically is presented from the perspective of the communicant's avatar, which increases the level of immersion experienced by the communicant. Each communicant typically is able to view any part of the virtual area 308 around his or her avatar. In some embodiments, the communications applications 26 establish realtime data stream connections between the first and second client network nodes 12, 14 and other network nodes sharing the virtual area 308 based on the positions of the communicants' avatars in the virtual area 308.

The network infrastructure service environment 306 also maintains the relationship database 36 that contains the records 38 of interactions between communicants. Each interaction record 38 describes the context of an interaction between a pair of communicants.

### B. Network Environment

The network 18 may include any of a local area network (LAN), a metropolitan area network (MAN), and a wide area network (WAN) (e.g., the internet). The network 18 typically includes a number of different computing platforms and transport facilities that support the transmission of a wide variety of different media types (e.g., text, voice, audio, and video) between network nodes.

The communications application 26 (see FIGS. 1 and 18) typically operates on a client network node that includes software and hardware resources which, together with administrative policies, user preferences (including preferences regarding the exportation of the user's presence and the connection of the user to areas and other users), and other settings, define a local configuration that influences the administration of realtime connections with other network nodes. The network connections between network nodes may be arranged in a variety of different stream handling topologies, including a peer-to-peer architecture, a server-mediated architecture, and hybrid architectures that combine aspects of peer-to-peer and server-mediated architectures. Exemplary topologies of these types are described in U.S. application Ser. Nos. 11/923,629 and 11/923,634, both of which were filed on Oct. 24, 2007.

### C. Network Infrastructure Services

The network infrastructure service environment 30 typically includes one or more network infrastructure services that cooperate with the communications applications 26 in the process of establishing and administering network connections between the client nodes 12, 14 and other network nodes (see FIGS. 1 and 18). The network infrastructure services may run on a single network node or may be distributed across multiple network nodes. The network infrastructure services typically run on one or more dedicated network nodes (e.g., a server computer or a network device that performs one or more edge services, such as routing and switching). In some embodiments, however, one or more of the network infrastructure services run on at least one of the communicants' network nodes. Among the network infrastructure services that are included in the exemplary embodiment of the network infrastructure service environment 30 are an account service, a security service, an area service, a rendezvous service, and an interaction service.

Account Service

The account service manages communicant accounts for the virtual environment. The account service also manages the creation and issuance of authentication tokens that can be used by client network nodes to authenticate themselves to any of the network infrastructure services.

Security Service

The security service controls communicants' access to the assets and other resources of the virtual environment. The access control method implemented by the security service typically is based on one or more of capabilities (where access is granted to entities having proper capabilities or permissions) and an access control list (where access is granted to entities having identities that are on the list). After a particular communicant has been granted access to a resource, that communicant typically uses the functionality provided by the other network infrastructure services to interact in the network communications environment 300.

Area Service

The area service administers virtual areas. In some embodiments, the area service remotely configures the communications applications 26 operating on the first and second client network nodes 12, 14 in accordance with the virtual area application 308 subject to a set of constraints 312 (see FIG. 18). The constraints 312 typically include controls on access to the virtual area. The access controls typically are based on one or more of capabilities (where access is granted to communicants or client nodes having proper capabilities or permissions) and an access control list (where access is granted to communicants or client nodes having identities that are on the list).

The area service also manages network connections that are associated with the virtual area subject to the capabilities of the requesting entities, maintains global state information for the virtual area, and serves as a data server for the client network nodes participating in a shared communication session in a context defined by the virtual area 308. The global state information includes a list of all the objects that are in the virtual area and their respective locations in the virtual area. The area service sends instructions that configure the client network nodes. The area service also registers and transmits initialization information to other client network nodes that request to join the communication session. In this process, the area service may transmit to each joining client network node a list of components (e.g., plugins) that are needed to render the virtual area 308 on the client network node in accordance with the virtual area application 310. The area service also ensures that the client network nodes can synchronize to a global state if a communications fault occurs. The area service typically manages communicant interactions with virtual areas via governance rules that are associated with the virtual areas.

Rendezvous Service

The rendezvous service manages the collection, storage, and distribution of presence information and provides mechanisms for network nodes to communicate with one another (e.g., by managing the distribution of connection handles) subject to the capabilities of the requesting entities. The rendezvous service typically stores the presence information in a presence database. The rendezvous service typically manages communicant interactions with each other via communicant privacy preferences.

Interaction Service

The interaction service maintains the relationship database 36 that contains the records 38 of interactions between communicants. For every interaction between communicants, one or more services of the network infrastructure service environment 306 (e.g., the area service) transmit interaction data to the interaction service. In response, the interaction service generates one or more respective interaction records and stores them in the relationship database. Each interaction record describes the context of an interaction between a pair of communicants. For example, in some embodiments, an interaction record contains an identifier for each of the communicants, an identifier for the place of interaction (e.g., a virtual area instance), a description of the hierarchy of the interaction place (e.g., a description of how the interaction room relates to a larger area), start and end times of the interaction, and a list of all files and other data streams that are shared or recorded during the interaction. Thus, for each realtime interaction, the interaction service tracks when it occurred, where it occurred, and what happened during the interaction in terms of communicants involved (e.g., entering and exiting), objects that are activated/deactivated, and the files that were shared.

The interaction service also supports queries on the relationship database 36 subject to the capabilities of the requesting entities. The interaction service presents the results of queries on the interaction database records in a sorted order (e.g., most frequent or most recent) based on virtual area. The query results can be used to drive a frequency sort of contacts whom a communicant has met in which virtual areas, as well as sorts of who the communicant has met with regardless of virtual area and sorts of the virtual areas the communicant frequents most often. The query results also may be used by application developers as part of a heuristic system that automates certain tasks based on relationships. An example of a heuristic of this type is a heuristic that permits communicants who have visited a particular virtual area more than five times to enter without knocking by default, or a heuristic that allows communicants who were present in an area at a particular time to modify and delete files created by another communicant who was present in the same area at the same time. Queries on the relationship database 36 can be combined with other searches. For example, queries on the relationship database may be combined with queries on contact history data generated for interactions with contacts using a communication system (e.g., Skype, Facebook, and Flickr) that is outside the domain of the network infrastructure service environment 306.

### D. Virtual Areas

The communications application 26 and the network infrastructure service environment 306 typically administer the realtime connections with network nodes in a communication context that is defined by an instance of a virtual area. The virtual area instance may correspond to an abstract (non-geometric) virtual space that is defined with respect to abstract coordinates. Alternatively, the virtual area instance may correspond to a visual virtual space that is defined with respect to one-, two- or three-dimensional geometric coordinates that are associated with a particular visualization. Abstract virtual areas may or may not be associated with respective visualizations, whereas visual virtual areas are associated with respective visualizations.

As explained above, communicants typically are represented by respective avatars (e.g., sprites) in a virtual area that has an associated visualization. The avatars move about the virtual area in response to commands that are input by the communicants at their respective network nodes. In some embodiments, the communicant's view of a virtual area instance typically is presented from the perspective of the communicant's avatar, and each communicant typically is able to view any part of the visual virtual area around his or her avatar, increasing the level of immersion that is experienced by the communicant.

A virtual area typically includes one or more zones that are associated with respective rules that govern the switching of realtime data streams between the network nodes that are represented by the avatars in the virtual area. The switching rules dictate how local connection processes executing on each of the network nodes establishes communications with the other network nodes based on the locations of the communicants' avatars in the zones of the virtual area. A virtual area typically is defined by a specification that includes a description of geometric elements of the virtual area and one or more rules, including switching rules and governance rules. The switching rules govern realtime stream connections between the network nodes. The governance rules control a communicant's access to resources, such as the virtual area itself, regions with the virtual area, and objects within the virtual area. In some embodiments, the geometric elements of the virtual area are described in accordance with the COLLADA—Digital Asset Schema Release 1.4.1 Apr. 2006 specification (available from http://www.khronos.org/collada/), and the switching rules are described using an extensible markup language (XML) text format (referred to herein as a virtual space description format (VSDL)) in accordance with the COLLADA Streams Reference specification described in U.S. application Ser. Nos. 11/923,629 and 11/923,634.

The geometric elements of the virtual area typically include physical geometry and collision geometry of the virtual area. The physical geometry describes the shape of the virtual area. The physical geometry typically is formed from surfaces of triangles, quadrilaterals, or polygons. Colors and textures are mapped onto the physical geometry to create a more realistic appearance for the virtual area. Lighting effects may be provided, for example, by painting lights onto the visual geometry and modifying the texture, color, or intensity near the lights. The collision geometry describes invisible surfaces that determine the ways in which objects can move in the virtual area. The collision geometry may coincide with the visual geometry, correspond to a simpler approximation of the visual geometry, or relate to application-specific requirements of a virtual area designer.

The switching rules typically include a description of conditions for connecting sources and sinks of realtime data streams in terms of positions in the virtual area. Each rule typically includes attributes that define the realtime data stream type to which the rule applies and the location or locations in the virtual area where the rule applies. In some embodiments, each of the rules optionally may include one or more attributes that specify a required role of the source, a required role of the sink, a priority level of the stream, and a requested stream handling topology. In some embodiments, if there are no explicit switching rules defined for a particular part of the virtual area, one or more implicit or default switching rules may apply to that part of the virtual area. One exemplary default switching rule is a rule that connects every source to every compatible sink within an area, subject to policy rules. Policy rules may apply globally to all connections between the client nodes or only to respective connections with individual client nodes. An example of a policy rule is a proximity policy rule that only allows connections of sources with compatible sinks that are associated with respective objects that are within a prescribed distance (or radius) of each other in the virtual area.

In some embodiments, governance rules are associated with a virtual area to control who has access to the virtual area, who has access to its contents, what is the scope of that access to the contents of the virtual-area (e.g., what can a user do with the contents), and what are the follow-on consequences of accessing those contents (e.g., record keeping, such as audit logs, and payment requirements). In some embodiments, an entire virtual area or a zone of the virtual area is associated with a “governance mesh.” In some embodiments, a governance mesh is implemented in a way that is analogous to the implementation of the zone mesh described in U.S. application Ser. Nos. 11/923,629 and 11/923,634. A governance mesh enables a software application developer to associate governance rules with a virtual area or a zone of a virtual area. This avoids the need for the creation of individual permissions for every file in a virtual area and avoids the need to deal with the complexity that potentially could arise when there is a need to treat the same document differently depending on the context.

In some embodiments, a virtual area is associated with a governance mesh that associates one or more zones of the virtual area with a digital rights management (DRM) function. The DRM function controls access to one or more of the virtual area or one or more zones within the virtual area or objects within the virtual area. The DRM function is triggered every time a communicant crosses a governance mesh boundary within the virtual area. The DRM function determines whether the triggering action is permitted and, if so, what is the scope of the permitted action, whether payment is needed, and whether audit records need to be generated. In an exemplary implementation of a virtual area, the associated governance mesh is configured such that if a communicant is able to enter the virtual area he or she is able to perform actions on all the documents that are associated with the virtual area, including manipulating the documents, viewing the documents, downloading the documents, deleting the documents, modifying the documents and re-uploading the documents. In this way, the virtual area can become a repository for information that was shared and discussed in the context defined by the virtual area.

Additional details regarding the specification of a virtual area are described in U.S. Application Nos. 61/042,714 (which was filed on Apr. 4, 2008), 11/923,629 (which was filed on Oct. 24, 2007), and 11/923,634 (which was filed on Oct. 24, 2007).

### E. Communications Application

In some embodiments, the communications application 26 includes:

a. local Human Interface Devices (HIDs) and audio playback devices;

b. a So3D graphical display, avatar, and physics engine;

c. a system database and storage facility.

1. Local Human Interface Devices (HIDS) and Audio Playback Devices

The local HIDs enable a communicant to input commands and other signals into the client network node while participating in a virtual area communications session. Exemplary HIDs include a computer keyboard, a computer mouse, a touch screen display, and a microphone.

The audio playback devices enable a communicant to playback audio signals that are received during a virtual area communications session. Exemplary audio playback devices include audio processing hardware (e.g., a sound card) for manipulating (e.g., mixing and applying special effects) audio signals, and speakers for outputting sounds.

2. So3D Graphical Display, Avatar, and Physics Engine

The So3D engine is a three-dimensional visualization engine that controls the presentation of a respective view of a virtual area and objects in the virtual area on a display monitor. The So3D engine typically interfaces with a graphical user interface driver and the HID devices to present the views of the virtual area and to allow the communicant to control the operation of the communications application 26.

In some embodiments, the So3D engine receives graphics rendering instructions from the area service. The So3D engine also may read a local communicant avatar database that contains images needed for rendering the communicant's avatar in the virtual area. Based on this information, the So3D engine generates a visual representation (i.e., an image) of the virtual area and the objects in the virtual area from the point of view (position and orientation) of the communicant's avatar in the virtual area. The visual representation typically is passed to the graphics rendering components of the operating system, which drive the graphics rendering hardware to render the visual representation of the virtual area on the client network node.

The communicant can control the presented view of the virtual area by inputting view control commands via a HID device (e.g., a computer mouse). The So3D engine updates the view of the virtual area in accordance with the view control commands. The So3D engine also updates the graphic representation of the virtual area on the display monitor in accordance with updated object position information received from the area service.

3. System Database and Storage Facility

The system database and storage facility stores various kinds of information that is used by the platform. Exemplary information that typically is stored by the storage facility includes the presence database, the relationship database, an avatar database, a real user id (RUID) database, an art cache database, and an area application database. This information may be stored on a single network node or it may be distributed across multiple network nodes.

### F. Client Node Architecture

A communicant typically connects to the network 18 from a client network node. The client network node typically is implemented by a general-purpose computer system or a dedicated communications computer system (or “console”, such as a network-enabled video game console). The client network node executes communications processes that establish realtime data stream connections with other network nodes and typically executes visualization rendering processes that present a view of each virtual area entered by the communicant.

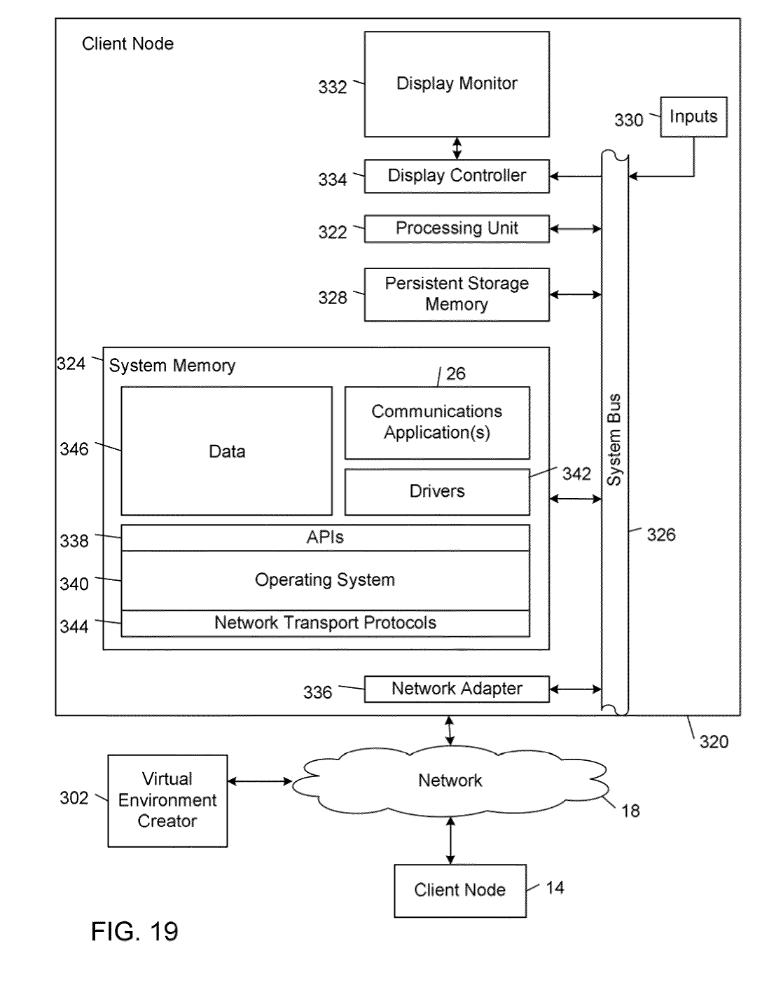

FIG. 19 shows an embodiment of a client network node that is implemented by a computer system 320. The computer system 320 includes a processing unit 322, a system memory 324, and a system bus 326 that couples the processing unit 322 to the various components of the computer system 320. The processing unit 322 may include one or more data processors, each of which may be in the form of any one of various commercially available computer processors. The system memory 324 includes one or more computer-readable media that typically are associated with a software application addressing space that defines the addresses that are available to software applications. The system memory 324 may include a read only memory (ROM) that stores a basic input/output system (BIOS) that contains start-up routines for the computer system 320, and a random access memory (RAM). The system bus 326 may be a memory bus, a peripheral bus or a local bus, and may be compatible with any of a variety of bus protocols, including PCI, VESA, Microchannel, ISA, and EISA. The computer system 320 also includes a persistent storage memory 328 (e.g., a hard drive, a floppy drive, a CD ROM drive, magnetic tape drives, flash memory devices, and digital video disks) that is connected to the system bus 326 and contains one or more computer-readable media disks that provide non-volatile or persistent storage for data, data structures and computer-executable instructions.

A communicant may interact (e.g., input commands or data) with the computer system 320 using one or more input devices 330 (e.g. one or more keyboards, computer mice, microphones, cameras, joysticks, physical motion sensors such Wii input devices, and touch pads). Information may be presented through a graphical user interface (GUI) that is presented to the communicant on a display monitor 332, which is controlled by a display controller 334. The computer system 320 also may include other input/output hardware (e.g., peripheral output devices, such as speakers and a printer). The computer system 320 connects to other network nodes through a network adapter 336 (also referred to as a “network interface card” or NIC).

A number of program modules may be stored in the system memory 324, including application programming interfaces 338 (APIs), an operating system (OS) 340 (e.g., the Windows XP® operating system available from Microsoft Corporation of Redmond, Wash. U.S.A.), the communications application 26, drivers 342 (e.g., a GUI driver), network transport protocols 344, and data 346 (e.g., input data, output data, program data, a registry, and configuration settings).

### G. Server Node Architecture

In some embodiments, the one or more server network nodes of the virtual environment creator 16 are implemented by respective general-purpose computer systems of the same type as the client network node 120, except that each server network node typically includes one or more server software applications.

In other embodiments, the one or more server network nodes of the virtual environment creator 16 are implemented by respective network devices that perform edge services (e.g., routing and switching).

### H. Exemplary Communication Session

Referring back to FIG. 17, during a communication session, each of the client network nodes generates a respective set of realtime data streams (e.g., motion data streams, audio data streams, chat data streams, file transfer data streams, and video data streams). For example, each communicant manipulates one or more input devices (e.g., the computer mouse 52 and the keyboard 54) that generate motion data streams, which control the movement of his or her avatar in the virtual area 66. In addition, the communicant's voice and other sounds that are generated locally in the vicinity of the computer system 48 are captured by the microphone 60. The microphone 60 generates audio signals that are converted into realtime audio streams. Respective copies of the audio streams are transmitted to the other network nodes that are represented by avatars in the virtual area 66. The sounds that are generated locally at these other network nodes are converted into realtime audio signals and transmitted to the computer system 48. The computer system 48 converts the audio streams generated by the other network nodes into audio signals that are rendered by the speakers 56, 58. The motion data streams and audio streams may be transmitted from each of the communicant nodes to the other client network nodes either directly or indirectly. In some stream handling topologies, each of the client network nodes receives copies of the realtime data streams that are transmitted by the other client network nodes. In other stream handling topologies, one or more of the client network nodes receives one or more stream mixes that are derived from realtime data streams that are sourced (or originated) from other ones of the network nodes.

In some embodiments, the area service maintains global state information that includes a current specification of the virtual area, a current register of the objects that are in the virtual area, and a list of any stream mixes that currently are being generated by the network node hosting the area service. The objects register typically includes for each object in the virtual area a respective object identifier (e.g., a label that uniquely identifies the object), a connection handle (e.g., a URI, such as an IP address) that enables a network connection to be established with a network node that is associated with the object, and interface data that identifies the realtime data sources and sinks that are associated with the object (e.g., the sources and sinks of the network node that is associated with the object). The objects register also typically includes one or more optional role identifiers for each object; the role identifiers may be assigned explicitly to the objects by either the communicants or the area service, or may be inferred from other attributes of the objects or the user. In some embodiments, the objects register also includes the current position of each of the objects in the virtual area as determined by the area service from an analysis of the realtime motion data streams received from the network nodes associated with objects in the virtual area. In this regard, the area service receives realtime motion data streams from the network nodes associated with objects in the virtual area, tracks the communicants' avatars and other objects that enter, leave, and move around in the virtual area based on the motion data. The area service updates the objects register in accordance with the current locations of the tracked objects.

In the process of administering realtime data stream connections with other network nodes, the area service maintains for each of the client network nodes a set of configuration data, including interface data, a zone list, and the positions of the objects that currently are in the virtual area. The interface data includes for each object associated with each of the client network nodes a respective list of all the sources and sinks of realtime data stream types that are associated with the object. The zone list is a register of all the zones in the virtual area that currently are occupied by the avatar associated with the corresponding client network node. When a communicant first enters a virtual area, the area service typically initializes the current object positions database with position initialization information. Thereafter, the area service updates the current object positions database with the current positions of the objects in the virtual area as determined from an analysis of the realtime motion data streams received from the other client network nodes sharing the virtual area.

### I. Interfacing with a Spatial Virtual Communication Environment

In addition to the local Human Interface Device (HID) and audio playback devices, the So3D graphical display, avatar, and physics engine, and the system database and storage facility, the communications application 26 also includes a graphical navigation and interaction interface (referred to herein as a “seeker interface”) that interfaces the user with the spatial virtual communication environment. The seeker interface includes navigation controls that enable the user to navigate the virtual environment and interaction controls that enable the user to control his or her interactions with other communicants in the virtual communication environment. The navigation and interaction controls typically are responsive to user selections that are made using any type of input device, including a computer mouse, a touch pad, a touch screen display, a keyboard, and a video game controller. The seeker interface is an application that operates on each client network node. The seeker interface is a small, lightweight interface that a user can keep up and running all the time on his or her desktop. The seeker interface allows the user to launch virtual area applications and provides the user with immediate access to realtime contacts and realtime collaborative places (or areas). The seeker interface is integrated with realtime communications applications and/or realtime communications components of the underlying operating system such that the seeker interface can initiate and receive realtime communications with other network nodes. A virtual area is integrated with the user's desktop through the seeker interface such that the user can upload files into the virtual environment created by the virtual environment creator 16, use files stored in association with the virtual area using the native client software applications independently of the virtual environment while still present in a virtual area, and more generally treat presence and position within a virtual area as an aspect of their operating environment analogous to other operating system functions rather than just one of several applications.

Additional details regarding the construction and operation of embodiments of the seeker interface are described in co-pending U.S. patent application Ser. No. 12/354,709, filed Jan. 15, 2009.

Any of the embodiments of the spatial interfaces that are described herein may be integrated into the seeker interface in order to provide a context for depicting the current communication of the communicants involved in realtime networked communications. Embodiments of these spatial interfaces also provide a context for organizing the presentation of various interface elements that are used by communicants to participate in realtime networked communications, as described above.

### V. CONCLUSION

The embodiments that are described herein provide improved systems and methods for visualizing realtime network communications. In particular, these embodiments apply a spatial metaphor on top of realtime networked communications. The spatial metaphor provides a context for depicting the current communication state of the communicants involved in realtime networked communications. The spatial metaphor also provides a context for organizing the presentation of various interface elements that are used by communicants to participate in realtime networked communications.

Other embodiments are within the scope of the claims.

1. A computer-implemented method, comprising:
establishing a current realtime communication session between communicants operating on respective network nodes;
on a display, displaying a spatial visualization of the current realtime communication session, wherein the spatial visualization comprises a graphical representation of each of the communicants in spatial relation to a graphical representation of a virtual area; and
during the current communication session, depicting visual cues in the spatial visualization that show current communication states of the communicants, wherein each of the communication states corresponds to a state of a respective communication channel over which a respective one of the communicants is configured to communicate.

2. The method of claim 1, further comprising, during the current communication session, presenting on the display a log of event descriptions describing respective events involving interactions of the communicants in the virtual area in contextual association with elements of the spatial visualization of the current realtime communication session.

3. The method of claim 2, wherein the log of event descriptions and the graphical representation of the virtual area are displayed in a single graphical user interface window.

4. The method of claim 2, wherein the log of event descriptions comprises at least one of: text of a chat conversation between the communicants in the virtual area; a description of a data file shared by a respective one of the communicants in the virtual area; and a description of an application shared by a respective one of the communicants in the virtual area.

5. The method of claim 2, wherein the presenting comprises visually associating the event descriptions in the log with respective ones of the graphical representations of the communicants involved in the events described by the respective event descriptions.

6. The method of claim 5, wherein the visually associating comprises associating with each of the event descriptions a respective label that has a respective visual appearance that matches a visual element of the graphical representation of the communicant involved in the event described by the respective event description.

7. The method of claim 2, further comprising storing the log of event descriptions in one or more database records that are indexed by an identifier of the virtual area.

8. The method of claim 1, wherein the displaying comprises displaying in the virtual area one or more props each representing a respective communication channel for realtime communications between the communicants during the communication session.

9. The method of claim 8, wherein the displaying comprises displaying a communicant-selectable table prop in the virtual area, and further comprising initiating a file share session between the communicants in response to selection of the table prop by one of the communicants.

10. The method of claim 8, wherein the displaying comprises displaying a communicant-selectable viewscreen prop in the virtual area, and further comprising initiating an application sharing session between the communicants in response to selection of the viewscreen prop by one of the communicants.

11. The method of claim 8, further comprising changing a spatial property of the graphical representation of a respective one of the communicants in relation to a respective one of the props in response to selection of the respective prop by the respective communicant.

12. The method of claim 11, wherein the changing comprises depicting the graphical representation of the respective communicant adjacent the selected prop.

13. The method of claim 11, wherein the changing comprises reorienting the graphical representation of the respective communicant to face the selected prop.

14. The method of claim 11, wherein the changing comprises changing the graphical representation of the respective communicant.

15. The method of claim 1, wherein the establishing comprises establishing during the current communication session a realtime instant messaging communication channel between the communicants.

16. The method of claim 15, wherein the displaying comprises displaying in association with the graphical representation of the virtual area a current chat log of a current chat conversation between the communicants occurring during the current communication session.

17. The method of claim 16, wherein the depicting comprises dynamically modulating the graphical representation of a given one of the communicants in response to receipt of a respective realtime chat stream from the given communicant over the realtime instant messaging communication channel such that the current communication state of the given communicant is reflected in the dynamic modulation of the graphical representation of the given communicant.

18. The method of claim 16, wherein the displaying comprises displaying in association with the current chat log a respective prior chat log of a prior chat conversation that occurred during a prior communication session between the communicants in the virtual area.

19. The method of claim 1, wherein the displaying comprises displaying a graphical representation of a file sharing prop in the virtual area, and further comprising: in response to selection of the file sharing prop by a respective one of the communicants, depicting the graphical representation of the respective communicant adjacent the file sharing prop, and initiating a realtime file sharing session in the virtual area.

20. The method of claim 19, further comprising storing a data file shared by the respective communicant during the realtime file sharing session in a data storage device with an index comprising an identifier of the virtual area, and wherein the displaying comprises displaying on the file sharing prop a communicant-selectable graphical representation of the data file.

21. The method of claim 20, further comprising initiating a download of the data file to the network node from which a given one of the communicants is operating in response to selection of the graphical representation of the file by the given communicant.

22. The method of claim 1, wherein the displaying comprises displaying a graphical representation of an application sharing prop in the virtual area, and further comprising: in response to selection of the application sharing prop by a respective one of the communicants, depicting the graphical representation of the respective communicant adjacent the application sharing prop, and initiating a realtime application sharing session in the virtual area.

23. The method of claim 22, further comprising sharing screen shots from the network node from which the respective communicant is operating with one or more of the other communicants during the realtime application sharing session, and wherein the displaying comprises displaying a graphical indication that an application that is being shared in connection with the application sharing prop.

24. The method of claim 22, wherein the displaying comprises displaying a first graphical representation of the application sharing prop during periods of application sharing between the communicants in the virtual area and displaying a second graphical representation of the application sharing prop different from the first graphical representation during periods free of application sharing between the communicants.

25. The method of claim 1, wherein in response to a command from a given one of the communicants to activate an audio sink communication channel, the establishing comprises establishing a realtime audio communication channel between the given communicant and one or more of the other communicants configured as audio sources, and the depicting comprises modifying the graphical representation of the given communicant to show that the given communicant is configured as an audio sink.

26. The method of claim 1, wherein in response to a command from a given one of the communicants to activate an audio source communication channel, the establishing comprises establishing a realtime audio communication channel between the given communicant and one or more of the other communicants configured as audio sinks, and the depicting comprises modifying the graphical representation of the given communicant to show that the given communicant is configured as an audio source.

27. The method of claim 1, wherein the displaying comprises displaying a static view of the graphical representation of the virtual area throughout the current communication session, and the communicants are unable to navigate the graphical representations of the communicants outside the static view of the virtual area.

28. The method of claim 1, wherein in response to receipt of a command from a first one of the communicants to initiate a private communication with a second one of the communicants: the establishing comprises establishing the current realtime communication session between the first and second communicants; and the displaying comprises displaying the graphical representations of the first and second communicants in spatial relation to a graphical representation of a virtual area that is indexed by identifiers of the first and second communicants.

29. The method of claim 1, further comprising determining an end state of a prior realtime communication session between the communicants from data that is indexed by an identifier of the virtual area and describes events that occurred during a prior communication session between the communicants; and wherein the displaying comprises displaying the graphical representation of a virtual area in a state that corresponds to the determined end state of the prior communication session between the communicants.

30. Apparatus, comprising:
a computer-readable medium storing computer-readable instructions; and
a data processor coupled to the computer-readable medium, operable to execute the instructions, and based at least in part on the execution of the instructions operable to perform operations comprising
establishing a current realtime communication session between communicants operating on respective network nodes,
on a display, displaying a spatial visualization of the current realtime communication session, wherein the spatial visualization comprises a graphical representation of each of the communicants in spatial relation to a graphical representation of a virtual area, and
during the current communication session, depicting visual cues in the spatial visualization that show current communication states of the communicants, wherein each of the communication states corresponds to a state of a respective communication channel over which a respective one of the communicants is configured to communicate.

31. At least one computer-readable medium having computer-readable program code embodied therein, the computer-readable program code adapted to be executed by a computer to implement a method comprising:
establishing a current realtime communication session between communicants operating on respective network nodes;
on a display, displaying a spatial visualization of the current realtime communication session, wherein the spatial visualization comprises a graphical representation of each of the communicants in spatial relation to a graphical representation of a virtual area; and
during the current communication session, depicting visual cues in the spatial visualization that show current communication states of the communicants, wherein each of the communication states corresponds to a state of a respective communication channel over which a respective one of the communicants is configured to communicate.

32. A computer-implemented method, comprising:
establishing a current realtime communication session between communicants operating on respective network nodes;
on a display, displaying a spatial visualization of the current realtime communication session, wherein the spatial visualization comprises a graphical representation of each of the communicants in spatial relation to a graphical representation of a virtual area; and
during the current communication session, on the display presenting a log of event descriptions describing respective events involving interactions of the communicants in the virtual area, wherein the event descriptions are presented in contextual association with elements of the spatial visualization of the current realtime communication session.

33. The method of claim 32, wherein the presenting comprises depicting a visual association between respective ones of the event descriptions in the log and elements of the spatial visualization of the current realtime communication session.

34. The method of claim 33, wherein the depicting comprises depicting a visual association between respective ones of the event descriptions in the log with respective ones of the graphical representations of the communicants involved in the events described by the respective event descriptions.

35. The method of claim 34, wherein the depicting comprises associating with each of one or more of the event descriptions a respective label that has a respective visual appearance that matches a visual element of the graphical representation of the communicant involved in the event described by the event description.

36. The method of claim 32, wherein in response to an entry of a respective one of the communicants into the virtual area, the displaying comprises adding the graphical representation of the respective communicant to the spatial visualization, and the presenting comprises presenting a respective one of the event descriptions describing the entry of the respective communicant into the virtual area.

37. The method of claim 32, wherein in response to a departure of a respective one of the communicants from the virtual area, the displaying comprises removing the graphical representation of the respective communicant from the spatial visualization, and the presenting comprises presenting a respective one of the event descriptions describing the departure of the respective communicant from the virtual area.

38. The method of claim 32, wherein in response to a sharing of a data file by a respective one of the communicants with other ones of the communicants, the displaying comprises displaying a communicant-selectable graphical representation of the data file in spatial relation to the graphical representation of the virtual area, and the presenting comprises presenting a respective one of the event descriptions describing the sharing of the data file by the respective communicant.

39. The method of claim 32, wherein in response to a sharing of an application by a respective one of the communicants with other ones of the communicants, the displaying comprises displaying a graphical indication of the sharing of the application in spatial relation to the graphical representation of the virtual area, and the presenting comprises presenting a respective one of the event descriptions describing the sharing of the application by the respective communicant.

40. Apparatus, comprising:
a computer-readable medium storing computer-readable instructions; and
a data processor coupled to the computer-readable medium, operable to execute the instructions, and based at least in part on the execution of the instructions operable to perform operations comprising
establishing a current realtime communication session between communicants operating on respective network nodes,
on a display, displaying a spatial visualization of the current realtime communication session, wherein the spatial visualization comprises a graphical representation of each of the communicants in spatial relation to a graphical representation of a virtual area and
during the current communication session, on the display presenting a log of event descriptions describing respective events involving interactions of the communicants in the virtual area, wherein the event descriptions are presented in contextual association with elements of the spatial visualization of the current realtime communication session.

41. At least one computer-readable medium having computer-readable program code embodied therein, the computer-readable program code adapted to be executed by a computer to implement a method comprising:
establishing a current realtime communication session between communicants operating on respective network nodes;
on a display, displaying a spatial visualization of the current realtime communication session, wherein the spatial visualization comprises a graphical representation of each of the communicants in spatial relation to a graphical representation of a virtual area; and
during the current communication session, on the display presenting a log of event descriptions describing respective events Involving interactions of the communicants in the virtual area, wherein the event descriptions are presented in contextual association with elements of the spatial visualization of the current realtime communication session.

42. A computer-implemented method, comprising in response to receipt of a command from a first communicant operating on a first network node to initiate a private communication with a second communicant operating on a second network node:
establishing a current realtime communication session between the first and second network nodes;
identifying a private virtual area associated with the first and second communicants;
retrieving context configuration data associated with the private virtual area and generated in response to interactions of the first and second communicants in the private virtual area; and
on a display, displaying a spatial visualization of the current realtime communication session, wherein the spatial visualization comprises graphical representations of the first and second communicants in spatial relation to a graphical representation of the virtual area configured in accordance with the context configuration data.

43. The method of claim 42, further comprising during the current realtime communication session, generating a log of event descriptions describing respective events involving interactions of the first and second communicants in the virtual area.

44. The method of claim 43, further comprising during the current realtime communication session, storing the event descriptions in a data storage device with an index comprising an identifier of the virtual area.

45. The method of claim 44, wherein the log of event descriptions comprises at least one of: text of a chat conversation between the first and second communicants in the virtual area; a description of a data file shared by a respective one of the first and second communicants in the virtual area; and a description of an application shared by a respective one of the first and second communicants in the virtual area.

46. The method of claim 43, further comprising during the current realtime communication session, presenting the log of event descriptions on the display.

47. The method of claim 46, wherein the presenting comprises presenting the log of event descriptions in contextual association with elements of the spatial visualization of the current realtime communication session.

48. The method of claim 46, wherein the retrieving comprises retrieving context configuration data comprising a log of event descriptions describing respective events involving interactions of the first and second communicants in the virtual area during one or more prior communication sessions before the current communication session, and the presenting comprises presenting the log of event descriptions generated during the current realtime communication session together with the retrieved context configuration data comprising the log of event descriptions.

49. The method of claim 42, wherein the retrieving comprises retrieving context configuration data comprising a description of an end state of a prior realtime communication session between the communicants, and the displaying comprises displaying the graphical representation of a virtual area in a state that corresponds to the end state of the prior communication session between the communicants.

50. Apparatus, comprising:
a computer-readable medium storing computer-readable instructions; and
a data processor coupled to the computer-readable medium, operable to execute the instructions, and based at least in part on the execution of the instructions operable to perform operations comprising in response to receipt of a command from a first communicant operating on a first network node to initiate a private communication with a second communicant operating on a second network node,
establishing a current realtime communication session between the first and second network nodes,
identifying a private virtual area associated with the first and second communicants,
retrieving context configuration data associated with the private virtual area and generated in response to interactions of the first and second communicants in the private virtual area, and
on a display, displaying a spatial visualization of the current realtime communication session, wherein the spatial visualization comprises graphical representations of the first and second communicants in spatial relation to a graphical representation of the virtual area configured in accordance with the context configuration data.

51. At least one computer-readable medium having computer-readable program code embodied therein, the computer-readable program code adapted to be executed by a computer to implement a method comprising:
in response to receipt of a command from a first communicant operating on a first network node to initiate a private communication with a second communicant operating on a second network node,
establishing a current realtime communication session between the first and second network nodes,
identifying a private virtual area associated with the first and second communicants,
retrieving context configuration data associated with the private virtual area and generated in response to interactions of the first and second communicants in the private virtual area, and
on a display, displaying a spatial visualization of the current realtime communication session, wherein the spatial visualization comprises graphical representations of the first and second communicants in spatial relation to a graphical representation of the virtual area configured in accordance with the context configuration data.
